(19) United States
(12) Patent Application Publication
(10) Pub. No.: US 2016/0234514 A1
(43) Pub. Date: Aug. 11, 2016

(54) DATA PROCESSING APPARATUS FOR TRANSMITTING/RECEIVING COMPRESSED PIXEL DATA GROUPS OF PICTURE AND INDICATION INFORMATION OF PIXEL DATA GROUPING SETTING AND RELATED DATA PROCESSING METHOD

(71) Applicant: MEDIATEK INC., Hsin-Chu, Taiwan (TW)

(72) Inventors: Chi-Cheng Ju, Hsinchu City (TW); Tsu-Ming Liu, Hsinchu City (TW)

(21) Appl. No.: 15/022,565

(22) PCT Filed: Oct. 10, 2014
(86) PCT No.: PCT/CN2014/088286

§ 371 Date: Mar. 17, 2016

Related U.S. Application Data
(60) Provisional application No. 61/892,227, filed on Oct. 17, 2013.

(51) Int. Cl. H04N 19/182; H04N 19/176; H04N 19/14; H04N 19/436; H04N 19/115

(52) U.S. Cl. CPC H04N 19/182; H04N 19/436; H04N 19/115; H04N 19/14; H04N 19/176

(57) ABSTRACT

A data processing apparatus has a mapper, a plurality of compressors, and an output interface. The mapper receives pixel data of a plurality of pixels of a picture, and splits the pixel data of the pixels of the picture into a plurality of pixel data groups. The compressors compress the pixel data groups and generate a plurality of compressed pixel data groups, respectively. The output interface packs the compressed pixel data groups into at least one output bitstream, and outputs the at least one output bitstream via a camera interface.

### CROSS REFERENCE TO RELATED APPLICATIONS

This application claims the benefit of U.S. provisional application No. 61/892,227, filed on Oct. 17, 2013 and incorporated herein by reference.

### TECHNICAL FIELD

The disclosed embodiments of the present invention relate to transmitting and receiving data over a camera interface, and more particularly, to a data processing apparatus for transmitting/receiving compressed pixel data groups of a picture and indication information of a pixel data grouping setting and a related data processing method.

### BACKGROUND

A camera interface is disposed between a first chip and a second chip to transmit multimedia data from the first chip to the second chip for further processing. For example, the first chip may include a camera module, and the second chip may include an image signal processor (ISP). The multimedia data may include image data (i.e., a single still image) or video data (i.e., a video sequence composed of successive images). When a camera sensor with a higher resolution is employed in the camera module, the multimedia data transmitted over the camera interface would have a larger data size/data rate, which increases the power consumption of the camera interface inevitably. If the camera module and the ISP are both located at a portable device (e.g., a smartphone) powered by a battery device, the battery life is shortened due to the increased power consumption of the camera interface. Thus, there is a need for an innovative design which can effectively reduce the power consumption of the camera interface.

### SUMMARY

In accordance with exemplary embodiments of the present invention, a data processing apparatus for transmitting/receiving compressed pixel data groups of a picture and indication information of a pixel data grouping setting and a related data processing method are proposed.

According to a first aspect of the present invention, an exemplary data processing apparatus is disclosed. The exemplary data processing apparatus includes a mapper, a plurality of compressors, and an output interface. The mapper is configured to receive pixel data of a plurality of pixels of a picture, and splitting the pixel data of the pixels of the picture into a plurality of pixel data groups. The compressors are configured to compress the pixel data groups and generate a plurality of compressed pixel data groups, respectively. The output interface is configured to pack the compressed pixel data groups into at least one output bitstream, and output the at least one output bitstream via a camera interface.

According to a second aspect of the present invention, an exemplary data processing apparatus is disclosed. The exemplary data processing apparatus includes an input interface, a plurality of de-compressors, and a de-mapper. The input interface is configured to receive at least one input bitstream from a camera interface, and un-pack the at least one input bitstream into a plurality of compressed pixel data groups of a picture. The de-compressors are configured to de-compress the compressed pixel data groups and generate a plurality of de-compressed pixel data groups, respectively. The de-mapper is configured to merge the de-compressed pixel data groups into pixel data of a plurality of pixels of the picture.

According to a third aspect of the present invention, an exemplary data processing apparatus is disclosed. The exemplary data processing apparatus includes a compression circuit, a first output interface, and a second output interface. The compression circuit is configured to generate a plurality of compressed pixel data groups by compressing pixel data of a plurality of pixels of a picture based on a pixel data grouping setting of the picture. The first output interface is configured to pack the compressed pixel data groups into an output bitstream, and output the output bitstream via a camera interface. The second output interface is distinct from the first output interface. Indication information is set in response to the pixel data grouping setting employed by the compression circuit, and outputted via one of the first output interface and the second output interface.

According to a fourth aspect of the present invention, an exemplary data processing apparatus is disclosed. The exemplary data processing apparatus includes a plurality of de-compressors, a first input interface, and a second input interface. Each of the de-compressors is configured to decompress a compressed pixel data group derived from an input bitstream when enabled. The first input interface is configured to receive the input bitstream via a camera interface. The second input interface is distinct from the first input interface. Indication information is received from one of the first input interface and the second interface, and multiple de-compressors selected from the de-compressors are enabled based on the received indication information.

According to a fifth aspect of the present invention, an exemplary data processing method is disclosed. The exemplary data processing method includes: receiving pixel data of a plurality of pixels of a picture, and splitting the pixel data of the pixels of the picture into a plurality of pixel data groups; compressing the pixel data groups to generate a plurality of compressed pixel data groups, respectively; and packing the compressed pixel data groups into at least one output bitstream, and outputting the at least one output bitstream via a camera interface.

According to a sixth aspect of the present invention, an exemplary data processing method is disclosed. The exemplary data processing method includes: receiving at least one input bitstream from a camera interface, and un-packing the at least one input bitstream into a plurality of compressed pixel data groups of a picture; de-compressing the compressed pixel data groups to generate a plurality of de-compressed pixel data groups, respectively; and merging the de-compressed pixel data groups into pixel data of a plurality of pixels of the picture.

According to a seventh aspect of the present invention, an exemplary data processing method is disclosed. The exemplary data processing method includes: generating a plurality of compressed pixel data groups by compressing pixel data of a plurality of pixels of a picture based on a pixel data grouping setting of the picture; packing the compressed pixel data groups into an output bitstream, and outputting the output bitstream via a camera interface. Indication information is set in response to the pixel data grouping setting, and output via one of the camera interface and an out-of-band channel distinct from the camera interface.

According to an eighth aspect of the present invention, an exemplary data processing method is disclosed. The exemplary data processing method includes: receiving an input bitstream via a camera interface; and enabling at least one de-compressor selected from a plurality of de-compressors based on indication information received from one of the camera interface and an out-of-band channel. The out-of-band channel is distinct from the camera interface, and each of the de-compressors is configured to decompress a compressed pixel data group derived from the input bitstream when enabled.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram illustrating a data processing system according to an embodiment of the present invention.

FIG. 2 is a diagram illustrating a pixel data splitting operation performed by a mapper based on a first pixel data grouping design.

FIG. 3 is a diagram illustrating a pixel data merging operation performed by a de-mapper based on the first pixel data grouping design.

FIG. 4 is a diagram illustrating a pixel data splitting operation performed by a mapper based on a second pixel data grouping design.

FIG. 5 is a diagram illustrating a pixel data merging operation performed by a de-mapper based on the second pixel data grouping design.

FIG. 6 is a diagram illustrating a first pixel segment based pixel data grouping design according to an embodiment of the present invention.

FIG. 7 is a diagram illustrating a second pixel segment based pixel data grouping design according to an embodiment of the present invention.

FIG. 8 is a flowchart illustrating a control and data flow of the data processing system shown in FIG. 1 according to an embodiment of the present invention.

FIG. 9 is a diagram illustrating a position-aware rate control mechanism according to an embodiment of the present invention.

FIG. 10 is a diagram illustrating an alternative design of step 806 in FIG. 8.

FIG. 11 is a diagram illustrating a modified compression mechanism according to an embodiment of the present invention.

FIG. 12 is a diagram illustrating an alternative design of step 808 in FIG. 8.

FIG. 13 is a block diagram illustrating another data processing system according to an embodiment of the present invention.

FIG. 14 is a diagram illustrating exemplary pixel data grouping patterns each dividing one picture in a first direction.

FIG. 15 is a diagram illustrating exemplary pixel data grouping patterns each dividing one picture in a second direction.

FIG. 16 is a diagram illustrating a data structure of an output bitstream generated from a camera module to an image signal processor according to an embodiment of the present invention.

FIG. 17 is a diagram illustrating an example of information handshaking between the camera module and the image signal processor.

FIG. 18 is a flowchart illustrating a control and data flow of a data processing system shown in FIG. 13 according to an embodiment of the present invention.

FIG. 19 is a diagram illustrating an example of using an I²C protocol with compression command according to an embodiment of the present invention.

FIG. 20 is a flowchart illustrating another control and data flow of a data processing system shown in FIG. 13 according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The present invention proposes applying data compression to a multimedia data and then transmitting a compressed multimedia data over a camera interface. As the data size/data rate of the compressed multimedia data is smaller than that of the original un-compressed multimedia data, the power consumption of the camera interface is reduced correspondingly. However, there may be a throughput bottleneck for a compression/de-compression system due to long data dependency of previous compressed/reconstructed data. To minimize or eliminate the throughput bottleneck of the compression/de-compression system, the present invention further proposes a data parallelism design. For example, the rate control intends to optimally or sub-optimally adjust the bit rate of each compression unit so as to achieve the content-aware bit budget allocation and therefore improve the visual quality. However, the rate control generally suffers from the long data dependency. When the proposed data parallelism design is employed, there will be a compromise between the processing throughput and the rate control performance. In this way, multiple compressed pixel data groups are independently generated at a transmitting end, and multiple de-compressed pixel data groups are independently generated at a receiving end. It should be noted that the proposed data parallelism design is not limited to enhancement of the rate control, any compression/de-compression system using the proposed data parallelism design falls within the scope of the present invention. Further details of the proposed data parallelism design are described in the first part of the specification.

In addition, the de-compression configuration employed by the receiving end is required to be compliant with the compression configuration employed by the transmitting end; otherwise, the receiving end fails to correctly de-compress the compressed multimedia data. The present invention further proposes transmitting/receiving indication information of a pixel data grouping setting via an in-band channel or an out-of-band channel, such that the de-compression configuration of the receiving end can be correctly configured based on the received indication information. Further details of the proposed information handshaking design are described in the second part of the specification.

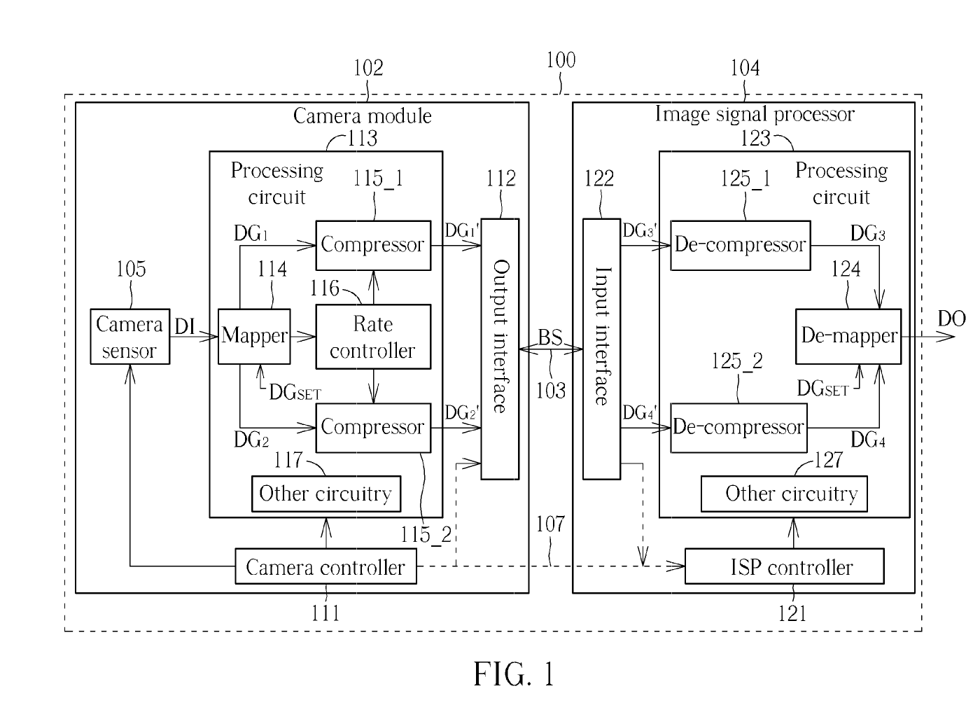

FIG. 1 is a block diagram illustrating a data processing system according to an embodiment of the present invention. The data processing system 100 includes a plurality of data processing apparatuses such as a camera module 102 and an image signal processor (ISP) 104. The image signal processor 104 may be part of an application processor (AP). The camera module 102 and the image signal processor 104 may be implemented in different chips, and the camera module 102 may communicate with the image signal processor 104 via a camera interface 103. In this embodiment, the camera interface 103 may be a camera serial interface (CSI) standardized by a Mobile Industry Processor Interface (MIPI).

The camera module 102 is coupled to the camera interface 103, and supports compressed data transmission. The camera module 102 includes a camera sensor 105, a camera controller 111, an output interface 112, and a processing circuit 113. The camera sensor 105 is used to obtain an input multimedia data. The input multimedia data obtained by the camera sensor 105 may be a single captured picture or a video sequence composed of a plurality of successive captured pictures. Besides, the input multimedia data obtained by the camera sensor 105 may be single view data for 2D display or multiple view data for 3D display. The input multimedia data may include pixel data DI of a plurality of pixels of one picture to be processed. As shown in FIG. 1, the processing circuit 113 includes circuit elements required for processing the pixel data DI to generate a plurality of compressed pixel data groups (e.g., two compressed pixel data groups DG₁′ and DG₂′ in this embodiment). For example, the processing circuit 113 has a mapper 114, a plurality of compressors (e.g., two compressors 115_1 and 115_2 in this embodiment), a rate controller 116, and other circuitry 117. For example, the other circuitry 117 may have a camera buffer, multiplexer(s), etc. In one exemplary design, the camera buffer may be used to buffer the pixel data DI, and output the buffered pixel data DI to the mapper 114 through a multiplexer. In another exemplary design, the pixel data DI may bypass the camera buffer and be directly fed into the mapper 114 through the multiplexer. In other words, the pixel data DI to be processed by the mapper 114 may be directly provided from the camera sensor 105 or indirectly provided from the camera sensor 105 through the camera buffer.

The mapper 114 acts as a splitter, and is configured to receive the pixel data DI of one picture and split the pixel data DI of one picture into a plurality of pixel data groups (e.g., two pixel data groups DG₁ and DG₂ in this embodiment) according to a pixel data group setting DG_{SET}. Further details of the mapper 114 will be described later. Since the pixel data DI is split into two pixel data groups DG₁ and DG₂, two compressors 115_1 and 115_2 are selected from multiple pre-built compressors in the processing circuit 113, and enabled to compress the pixel data groups DG₁ and DG₂ to generate compressed pixel data groups DG₁′ and DG₂′, respectively. In other words, the number of enabled compressors depends on the number of pixel data groups generated from the mapper 114.

Each of the compressors 115_1 and 115_2 may employ a lossless compression algorithm or a lossy compression algorithm, depending upon the actual design consideration. The rate controller 116 is configured to apply bit rate control (i.e., bit budget allocation) to the compressors 115_1 and 115_2, respectively. In this way, each of the compressed pixel data groups DG₁′ and DG₂′ is generated at a desired bit rate. In this embodiment, compression operations performed by the compressors 115_1 and 115_2 are independent of each other, thus enabling rate control with data parallelism. Since the long data dependency is alleviated, the rate control performance can be improved.

The output interface 112 is configured to pack/packetize the compressed pixel data groups DG₁′ and DG₂′ into at least one output bitstream according to the transmission protocol of the camera interface 103, and transmit the at least one output bitstream to the image signal processor 104 via the camera interface 103. By way of example, one bitstream BS may be generated from the camera module 102 to the image signal processor 104 via one camera port of the camera interface 103.

Regarding the image signal processor 104, it communicates with the camera module 102 via the camera interface 103. In this embodiment, the image signal processor 104 is coupled to the camera interface 103, and supports compressed data reception. When the camera module 102 transmits compressed multimedia data (e.g., compressed pixel data groups DG₁′ and DG₂′ packed in the bitstream BS) to the image signal processor 104, the image signal processor 104 is configured to receive the compressed multimedia data from the camera interface 103 and derive reconstructed multimedia data from the compressed multimedia data.

As shown in FIG. 1, the image signal processor 104 includes an ISP controller 121, an input interface 122 and a processing circuit 123. The input interface 122 is configured to receive at least one input bitstream from the camera interface 103 (e.g., the bitstream BS received by one camera port of the camera interface 103), and un-pack/un-packetize the at least one input bitstream into a plurality of compressed pixel data groups of a picture (e.g., two compressed pixel data groups DG₃′ and DG₄′ in this embodiment). It should be noted that, if there is no error introduced during the data transmission, the compressed pixel data group DG₃′ generated from the input interface 122 should be identical to the compressed pixel data group DG₁′ received by the output interface 112, and the compressed pixel data group DG₄′ generated from the input interface 122 should be identical to the compressed pixel data group DG₂′ received by the output interface 112.

The processing circuit 123 may include circuit elements required for deriving reconstructed multimedia data from the compressed multimedia data, and may further include other circuit element(s) used for applying additional processing before outputting pixel data DO of a plurality of pixels of a reconstructed picture. For example, the processing circuit 123 has a de-mapper 124, a plurality of de-compressors (e.g., two de-compressors 125_1 and 125_2 in this embodiment), and other circuitry 127. For example, the other circuitry 127 may have direct memory access (DMA) controllers, multiplexers, switches, an image processor, a camera processor, a video processor, a graphic processor, etc. The de-compressor 125_1 is configured to de-compress the compressed pixel data group DG₃′ to generate a de-compressed pixel data group DG₃, and the de-compressor 125_2 is configured to de-compress the compressed pixel data group DG₄′ to generate a de-compressed pixel data group DG₄. In this embodiment, the de-compression operations performed by the de-compressors 125_1 and 125_2 are independent of each other. In this way, the de-compression throughput can be improved due to data parallelism.

The de-compression algorithm employed by each of the de-compressors 125_1 and 125_2 should be properly configured to match the compression algorithm employed by each of the compressors 115_1 and 115_2. In other words, the de-compressors 125_1 and 125_2 are configured to perform lossless de-compression when the compressors 115_1 and 115_2 are configured to perform lossless compression; and the de-compressors 125_1 and 125_2 are configured to perform lossy de-compression when the compressors 115_1 and 115_2 are configured to perform lossy compression. If there is no error introduced during the data transmission and a lossless compression algorithm is employed by the compressors 115_1 and 115_2, the de-compressed pixel data group DG₃ fed into the de-mapper 124 should be identical to the pixel data group DG₁ generated from the mapper 114, and the de-compressed pixel data group DG₄ fed into the de-mapper 124 should be identical to the pixel data group DG₂ generated from the mapper 114.

The de-mapper 124 acts as a combiner, and is configured to merge the de-compressed pixel data groups into pixel data DO of a plurality of pixels of a reconstructed picture based on the pixel data grouping setting DG_{SET} that is employed by the mapper 114. The pixel data grouping setting DG_{SET} employed by the mapper 114 may be transmitted from the camera module 102 to the image signal processor 104 via an in-band channel (i.e., camera interface 103) or an out-of-band channel 107. For example, the out-of-band channel 107 may be an I²C (Inter-Integrated Circuit) bus. For another example, the out-of-band channel 107 may be a control bus, such as a camera control interface (CCI), for MIPI's CSI interface.

Specifically, the camera controller 111 controls the operation of the camera module 102, and the ISP controller 121 controls the operation of the image signal processor 104. Hence, the camera controller 111 may first check a de-compression capability and requirement of the image signal processor 104, and then determine the number of pixel data groups in response to a checking result. In addition, the camera controller 111 may further determine the pixel data grouping setting DG_{SET} employed by the mapper 114 to generate the pixel data groups that satisfy the de-compression capability and requirement of the image signal processor 104, and transmit the pixel data grouping setting DG_{SET}. When receiving a query issued from the camera controller 111, the ISP controller 121 may inform the camera controller 111 of the de-compression capability and requirement of the image signal processor 104. In addition, when receiving the pixel data grouping setting DG_{SET} from camera interface 103 or out-of-band channel 107, the ISP controller 121 may control the de-mapper 124 to perform the pixel data merging operation based on the received pixel data grouping setting DG_{SET}. Further description of the proposed information handshaking mechanism will be detailed later.

Concerning the data parallelism, the present invention proposes several pixel data grouping designs that can be used to split pixel data of a plurality of pixels of one picture into multiple pixel data groups. Examples of the proposed pixel data grouping designs are detailed as below.

As pixel data DI of pixels of one picture is generated from the camera sensor 105, the pixel data format of each pixel depends on the design of the camera sensor 105. For example, when the camera sensor 105 employs a BGGR Bayer pattern color filter array (CFA), each pixel mentioned hereinafter may include one blue color component (B), two green color components (G), and one red color component (R). For another example, when the camera sensor 105 employs a Bayer pattern CFA and performs color demosaicing in YUV color space, each pixel mentioned hereinafter may include one luminance component (Y) and two chrominance components (U, V). It should be noted that this is for illustrative purposes only, and is not meant to be a limitation of the present invention. A skilled person should readily appreciate that the proposed pixel data grouping design can be applied to any pixel data format supported by the camera sensor 105.

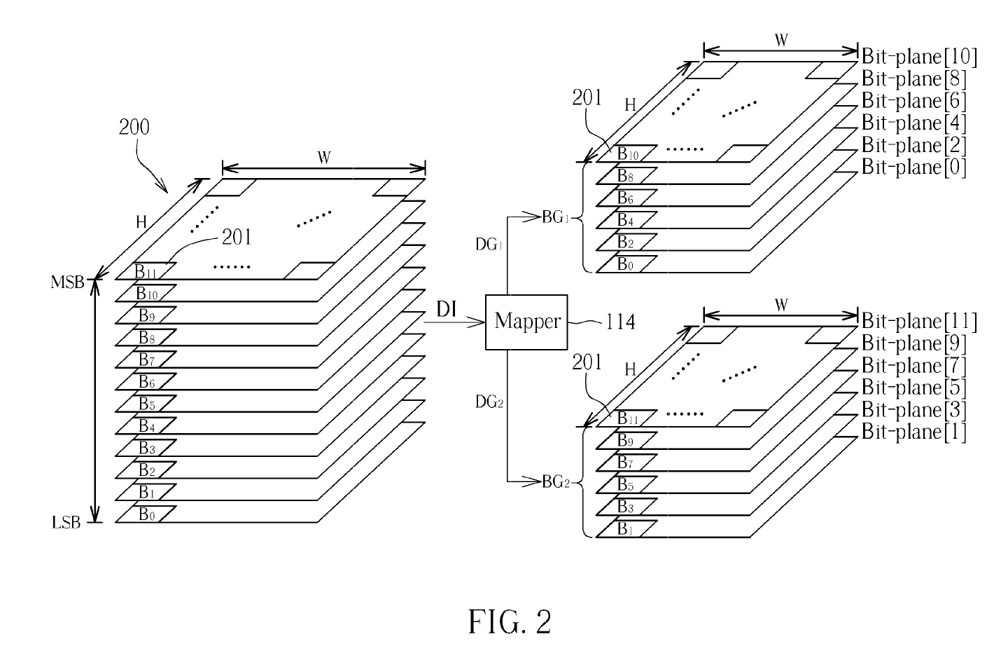

In a first pixel data grouping design, the mapper 114 splits the pixel data DI of pixels of one picture by dividing bit depths/bit planes into different groups. FIG. 2 is a diagram illustrating a pixel data splitting operation performed by the mapper 114 based on the first pixel data grouping design. As shown in FIG. 2, the width of a picture 200 is W, and the height of the picture 200 is H. Thus, the picture 200 has W×H pixels 201. In this embodiment, pixel data of each pixel 201 has a plurality of bits corresponding to different bit planes. For example, each pixel 201 has 12 bits B₀-B₁₁ for each color channel (e.g., R/G/B or Y/U/V). The bits B₀-B₁₁ correspond to different bit planes Bit-plane[0]-Bit-plane[11]. Specifically, the least significant bit (LSB) B₀ corresponds to the bit plane Bit-plane[0], and the most significant bit (MSB) B₁₁ corresponds to the bit plane Bit-plane[11]. When the first pixel data grouping design is employed, the camera controller 111 controls the pixel data grouping setting DG_{SET} to instruct the mapper 114 to split bits of the pixel data of each pixel into a plurality of bit groups (e.g., two bit groups BG₁ and BG₂ in this embodiment), and distribute the bit groups to the pixel data groups (e.g., pixel data groups DG₁ and DG₂ in this embodiment), respectively. Concerning bits B₀-B₁₁ of different color channels (e.g., BGGR or YUV)) of each pixel 201, the mapper 114 may categorize even bits B₀, B₂, B₄, B₆, B₈, B₁₀ as one bit group BG₁, and categorize odd bits B₁, B₃, B₅, B₇, B₉, B₁₁ as another bit group BG₂. However, this is for illustrative purposes only, and is not meant to be a limitation of the present invention. In an alternative design, the mapper 114 may categorize more significant bits B₆-B₁₁ as one bit group BG₁, and categorize less significant bits B₀-B₅ as another bit group BG₂. In short, any bit interleaving manner capable of splitting bits of pixel data of each pixel 201 of the picture 200 into multiple bit groups may be employed by the mapper 114.

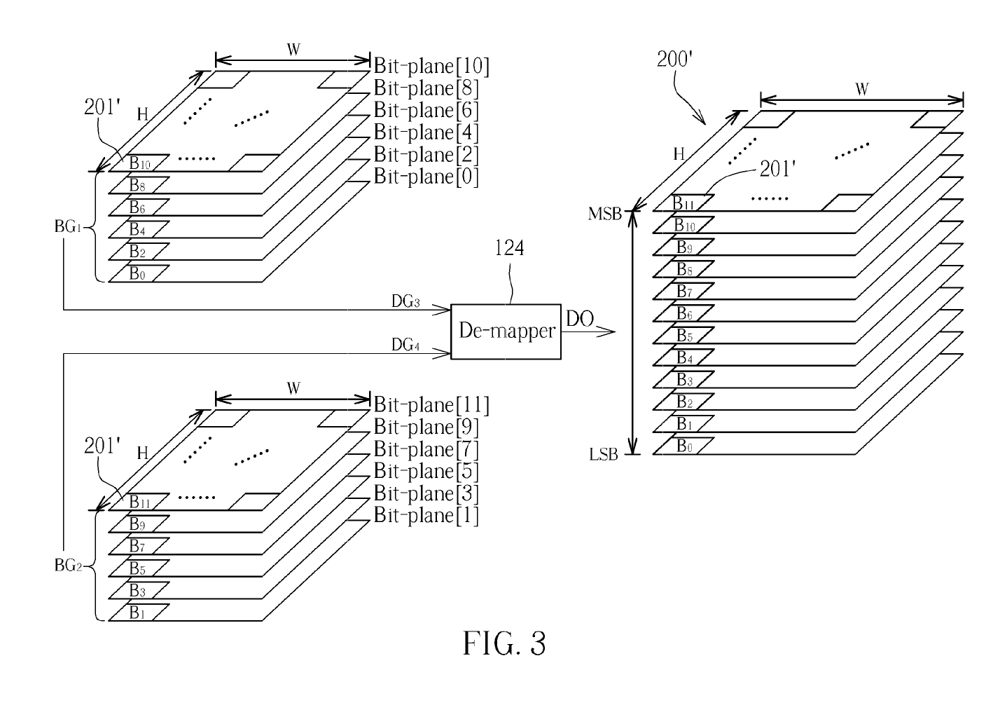

As mentioned above, the pixel data groups DG₁ and DG₂ are transmitted from the camera module 102 to the image signal processor 104 after undergoing data compression. Hence, the image signal processor 104 obtains one de-compressed pixel data group DG₃ corresponding to the pixel data group DG₁ and another de-compressed pixel data group DG₄ corresponding to the pixel data group DG₂ after data de-compression is performed. FIG. 3 is a diagram illustrating a pixel data merging operation performed by the de-mapper 124 based on the first pixel data grouping design. The operation of the de-mapper 124 may be regarded as an inverse of the operation of the mapper 114. Hence, based on the pixel data grouping setting DG_{SET} employed by the mapper 114, the de-mapper 124 obtains a plurality of bit groups (e.g., two bit groups BG₁ and BG₂ in this embodiment) from the de-compressed pixel data groups (e.g., two de-compressed pixel data groups DG₃ and DG₄ in this embodiment), respectively, and merge the bit groups to obtain bits of pixel data of each pixel 201′ of a reconstructed picture 200′. The resolution of the reconstructed picture 200′ generated at the image signal processor 104 is identical to the resolution of the picture 200 processed in the camera module 102. Hence, the width of the reconstructed picture 200′ is W, and the height of the reconstructed picture 200′ is H. The pixel data of each pixel 201′ of the reconstructed picture 200′ includes a plurality of bits B₀-B₁₁ corresponding to different bit planes Bit-plane[0]-Bit-plane[11]. For example, each color channel (e.g., R/G/B or Y/U/V) of one pixel 201′ in the reconstructed 200′ includes 12 bits B₀-B₁₁. The de-mapper 124 may obtain the bit group BG₁ composed of even bits B₀, B₂, B₄, B₆, B₈, B₁₀ of color channels of a pixel 201′, obtain another bit group BG₂ composed of odd bits B₁, B₃, B₅, B₇, B₉, B₁₁ of color channels of the pixel 201′, and merge the bit groups BG₁ and BG₂ to recover all bits B₀-B₁₁ of the pixel data of the pixel 201′. However, this is for illustrative purposes only, and is not meant to be a limitation of the present invention. In another case where the mapper 114 categorizes more significant bits B₆-B₁₁ as one bit group BG₁ and categorizes less significant bits B₀-B₅ as another bit group BG₂, the de-mapper 124 may obtain the bit group BG₁ composed of more significant bits B₆-B₁₁ of color channels of a pixel 201′, obtain another bit group BG₂ composed of less significant bits B₀-B₅ of color channels of the pixel 201′, and merge the bit groups BG₁ and BG₂ to recover all bits B₀-B₁₁ of the pixel data of the pixel 201′. To put it simply, the bit de-interleaving manner employed by the de-mapper 124 depends on the bit interleaving manner employed by the mapper 114.

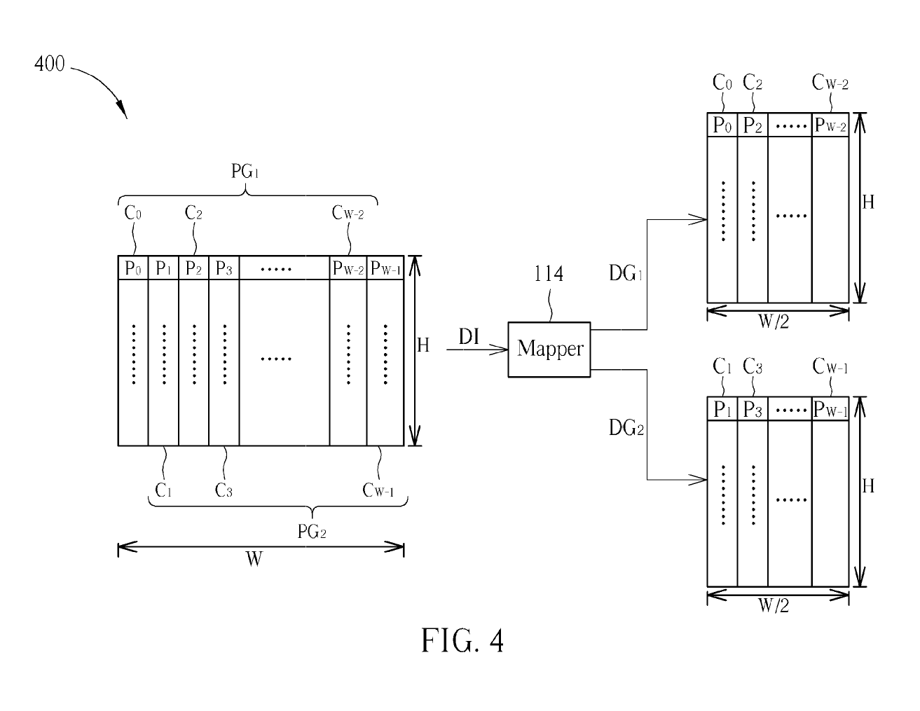

In a second pixel data grouping design, the mapper 114 splits the pixel data DI of pixels of one picture by dividing complete pixels into different groups. FIG. 4 is a diagram illustrating a pixel data splitting operation performed by the mapper 114 based on the second pixel data grouping design. As shown in FIG. 4, the width of a picture 400 is W, and the height of the picture 400 is H. Thus, the picture 400 has W×H pixels. As shown in FIG. 4, pixels located at the same pixel line (e.g., the same pixel row in this embodiment) include a plurality of pixels P₀, P₁, P₂, P₃ . . . P_{W-2}, P_{W-1}. When the second pixel data grouping design is employed, the camera controller 111 controls the pixel data grouping setting DG_{SET} to instruct the mapper 114 to split pixels of the picture 400 into a plurality of pixel groups (e.g., two pixel groups PG₁ and PG₂ in this embodiment), and distribute pixel data of the pixel groups to the pixel data groups (e.g., two pixel data groups DG₁ and DG₂ in this embodiment), respectively. For example, adjacent pixels located at the same pixel line (e.g., the same pixel row) are distributed to different groups, respectively. Hence, the pixel group PG₁ includes all pixels of even pixel columns C₀, C₂ . . . C_{W-2} of the picture 400, and the pixel group PG₁ includes all pixels of the odd pixel columns C₁, C₃ . . . C_{W-1} of the picture 400. As shown in FIG. 4, the pixel data group DG₁ includes pixel data of H×(W/2) pixels, and the pixel data group DG₂ includes pixel data of H×(W/2) pixels. However, this is for illustrative purposes only, and is not meant to be a limitation of the present invention. In an alternative design, the aforementioned pixel line may be a pixel column. Hence, adjacent pixels located at the same pixel column are distributed to different groups, respectively. The pixel group PG₁ may include all pixels of even pixel columns of the picture 400, and the pixel group PG₂ may include all pixels of the odd pixel columns of the picture 400. In other words, the pixel data group DG₁ may be formed by gathering pixel data of (H/2)×W pixels, and the pixel data group DG₂ may be formed by gathering pixel data of (H/2)×W pixels. To put it simply, any pixel interleaving manner capable of splitting adjacent pixels of the picture 400 into different pixel groups may be employed by the mapper 114.

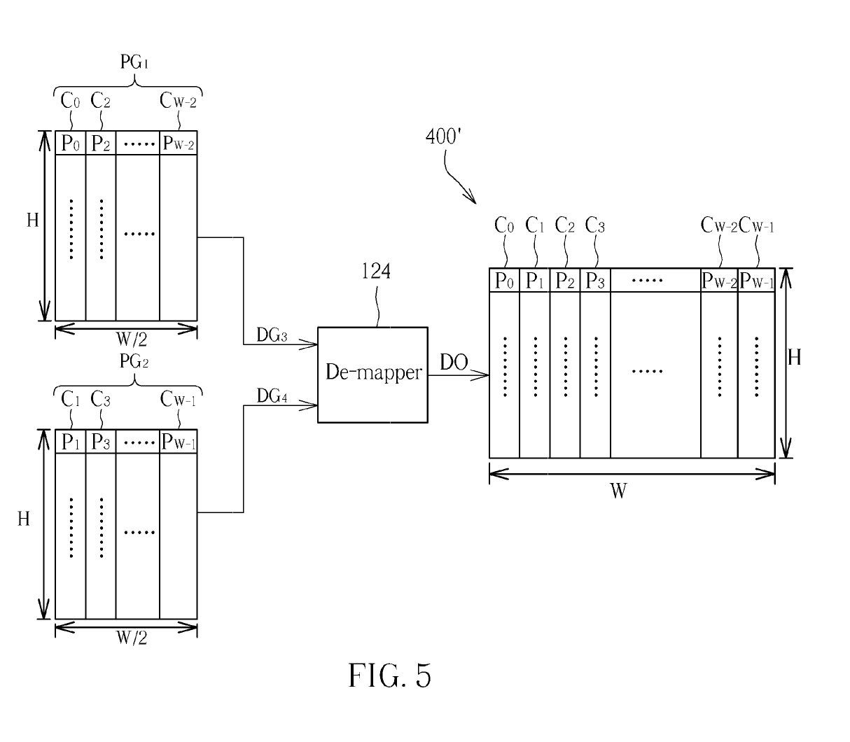

As mentioned above, the pixel data groups DG₁ and DG₂ are transmitted from the camera module 102 to the image signal processor 104 after undergoing data compression. Hence, the image signal processor 104 obtains one de-compressed pixel data group DG₃ corresponding to the pixel data group DG₁ and another de-compressed pixel data group DG₄ corresponding to the pixel data group DG₂ after data de-compression is performed. FIG. 5 is a diagram illustrating a pixel data merging operation performed by the de-mapper 124 based on the second pixel data grouping design. The operation of the de-mapper 124 may be regarded as an inverse of the operation of the mapper 114. Hence, based on the pixel data grouping setting DG_{SET} employed by the mapper 114, the de-mapper 124 obtains pixel data of a plurality of pixel groups (e.g., two pixel groups PG₁ and PG₂ in this embodiment) from the de-compressed pixel data groups (e.g., two pixel data groups DG₃ and DG₄ in this embodiment), respectively, and merge the pixel data of the pixel groups to obtain pixel data of pixels of a reconstructed picture 400′, where adjacent pixels located at the same pixel line (e.g., the same pixel row) of the reconstructed picture 400′ are obtained from different pixel groups, respectively. However, this is for illustrative purposes only, and is not meant to be a limitation of the present invention. In another case where the mapper 114 distributes adjacent pixels located at the same pixel column to different groups, respectively, the de-mapper 124 may obtain pixel data of a plurality of pixel groups from the de-compressed pixel data groups, respectively, and merge the pixel data of the pixel groups obtain pixel data of pixels of the reconstructed picture 400′, where adjacent pixels located at the same pixel column of the reconstructed picture 400′ are obtained from different pixel groups, respectively. To put it simply, the pixel de-interleaving manner employed by the de-mapper 124 depends on the pixel interleaving manner employed by the mapper 114.

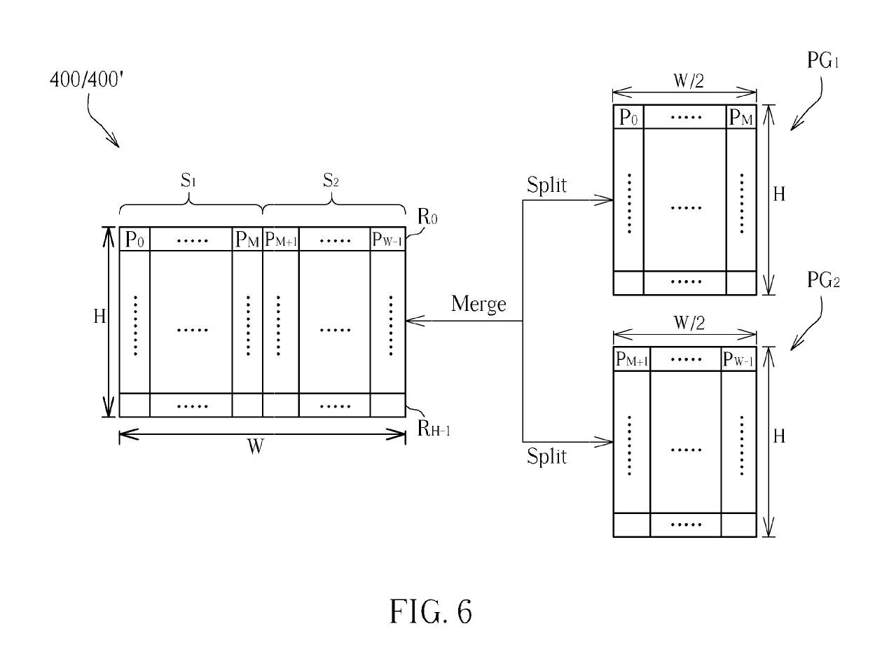

Regarding the second pixel data grouping design mentioned above, the pixels are categorized into different pixel groups in a single-pixel based manner. In one alternative design, the pixels may be categorized into different pixel groups in a pixel segment based manner, where each pixel segment includes a plurality of successive pixels located at the same pixel line (e.g., the same pixel row or the same pixel column). FIG. 6 is a diagram illustrating a first pixel segment based pixel data grouping design according to an embodiment of the present invention. Each of the pixel lines (e.g., pixel rows R₀-R_{H-1} in this embodiment) is divided into a plurality of pixel segments (e.g., two pixel segments S₁ and S₂ in this embodiment), and the number of the pixel segments located at the same pixel line is equal to the number of pixel data groups (e.g., two pixel data groups DG₁ and DG₂ in this embodiment). Concerning the pixel data splitting operation, adjacent pixel segments located at the same pixel line (e.g., the same pixel row in this embodiment) are distributed to different pixel groups (e.g., two pixel groups PG₁ and PG₂ in this embodiment), respectively. Hence, as shown in FIG. 6, the pixel group PG₁ is composed of pixel segments 51 each extracted from one of the pixel rows R₀-R_{H-1} of the picture 400, and the pixel group PG₂ is composed of pixel segments S2 each extracted from one of the pixel rows R₀-R_{H-1} of the picture 400.

Concerning the pixel data merging operation, adjacent pixel segments located at the same pixel line (e.g., the same pixel row in this embodiment) are obtained from different pixel groups (e.g., two pixel groups PG₁ and PG₂ in this embodiment), respectively. Hence, as shown in FIG. 6, the reconstructed picture 400′ has pixel rows R₀-R_{H-1} each reconstructed by merging one pixel segment S₁ obtained from the pixel group PG₁ and another pixel segment S₂ obtained from the pixel group PG₂.

It should be noted that the aforementioned pixel line may be a pixel column in another exemplary implementation. Therefore, each of the pixel columns is divided into a plurality of pixel segments, and the number of the pixel segments located at the same pixel column is equal to the number of pixel data groups. Concerning the pixel data splitting operation, adjacent pixel segments located at the same pixel column are distributed to different pixel groups, respectively. Concerning the pixel data merging operation, adjacent pixel segments located at the same pixel column are obtained from different pixel groups, respectively.

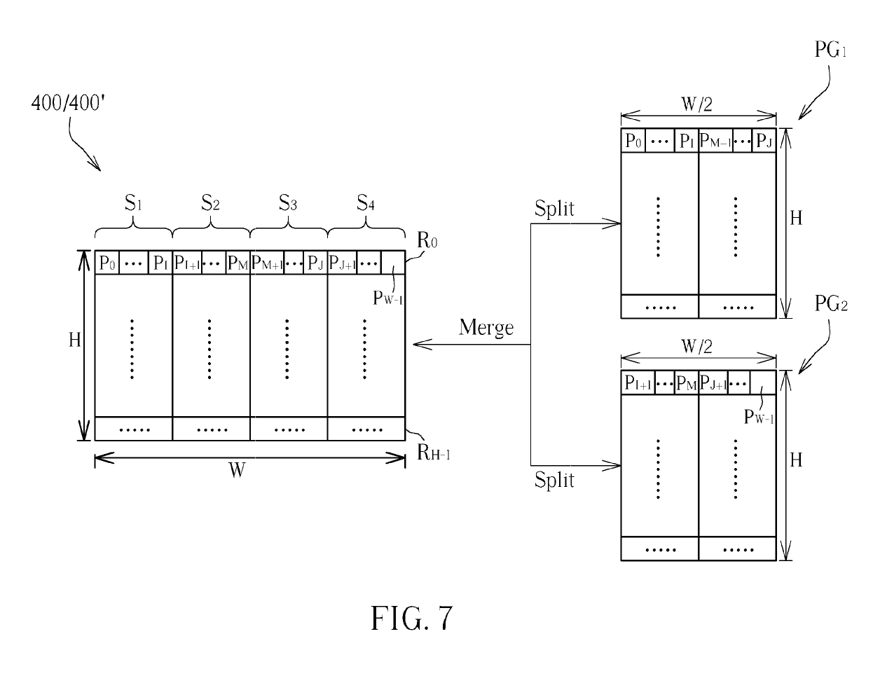

FIG. 7 is a diagram illustrating a second pixel segment based pixel data grouping design according to an embodiment of the present invention. Each of the pixel lines (e.g., pixel rows R₀-R_{H-1} in this embodiment) is divided into a plurality of pixel segments (e.g., four pixel segments S₁, S₂, S₃ and S₄ in this embodiment), and the number of the pixel segments located at the same pixel line is larger than the number of pixel data groups (e.g., two pixel data groups DG₁ and DG₂ in this embodiment). Concerning the pixel data splitting operation, adjacent pixel segments located at the same pixel line (e.g., the same pixel row in this embodiment) are distributed to different pixel groups (e.g., two pixel groups PG₁ and PG₂ in this embodiment), respectively. Hence, as shown in FIG. 7, the pixel group PG₁ is composed of pixel segments S₁, each extracted from one of the pixel rows R₀-R_{H-1} of the picture 400, and pixel segments S₃, each extracted from one of the pixel rows R₀-R_{H-1} of the picture 400; and the pixel group PG₂ is composed of pixel segments S₂, each extracted from one of the pixel rows R₀-R_{H-1} of the picture 400, and pixel segments S₄, each extracted from one of the pixel rows R₀-R_{H-1} of the picture 400. Concerning the pixel data merging operation, adjacent pixel segments located at the same pixel line (e.g., the same pixel row in this embodiment) are obtained from different pixel groups (e.g., two pixel groups PG₁ and PG₂ in this embodiment), respectively. Hence, as shown in FIG. 7, the reconstructed picture 400′ has pixel rows R₀-R_{H-1} each reconstructed by merging pixel segments S₁ and S₃ both obtained from the pixel group PG₁ and pixel segments S₂ and S₄ both obtained from the pixel group PG₂.

It should be noted that the aforementioned pixel line may be a pixel column in another exemplary implementation. Therefore, each of the pixel columns is divided into a plurality of pixel segments, and the number of the pixel segments located at the same pixel column is larger than the number of pixel data groups. Concerning the pixel data splitting operation, adjacent pixel segments located at the same pixel column are distributed to different pixel groups, respectively. Concerning the pixel data merging operation, adjacent pixel segments located at the same pixel column are obtained from different pixel groups, respectively.

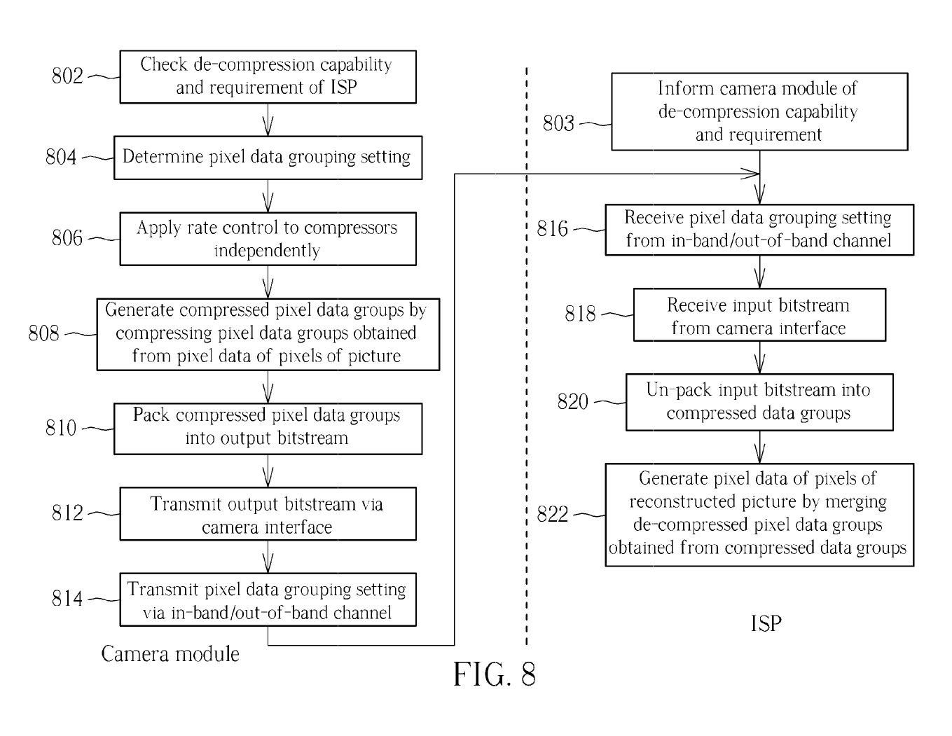

FIG. 8 is a flowchart illustrating a control and data flow of the data processing system shown in FIG. 1 according to an embodiment of the present invention. Provided that the result is substantially the same, the steps are not required to be executed in the exact order shown in FIG. 8. The exemplary control and data flow may be briefly summarized by following steps.

Step 802: Check a de-compression capability and requirement of an image signal processor (ISP).

Step 803: Inform a camera module of the de-compression capability and requirement.

Step 804: Determine a pixel data grouping setting according to a checking result.

Step 806: Apply rate control to a plurality of compressors, independently.

Step 808: Generate a plurality of compressed pixel data groups by using the compressors to compress a plurality of pixel data groups obtained from pixel data of a plurality of pixels of a picture based on the pixel data grouping setting. For example, the pixel data groups may be generated based on any of the proposed pixel data grouping designs shown in FIG. 2, FIG. 4, FIG. 6 and FIG. 7.

Step 810: Pack/packetize the compressed pixel data groups into an output bitstream.

Step 812: Transmit the output bitstream via a camera interface.

Step 814: Transmit the pixel data grouping setting via an in-band channel (i.e., camera interface) or an out-of-band channel (e.g., I²C bus or CCI bus).

Step 816: Receive the pixel data grouping setting from the in-band channel (i.e., camera interface) or the out-of-band channel (e.g., I²C bus or CCI bus).

Step 818: Receive an input bitstream from the camera interface.

Step 820: Un-pack/un-packetize the input bitstream into a plurality of compressed data groups.

Step 822: Generate pixel data of a plurality of pixels of a reconstructed picture by using a plurality of de-compressors to de-compress the compressed pixel data groups, independently, and then merging a plurality of de-compressed pixel data groups based on the pixel data grouping setting.

It should be noted that steps 802 and 804-814 are performed by the camera module 102, and steps 803 and 816-822 are performed by the image signal processor 104. As a person skilled in the art can readily understand details of each step shown in FIG. 8 after reading above paragraphs, further description is omitted here for brevity.

Moreover, the proposed data parallelism scheme may be inactivated when using a single compressor at the camera side and a single de-compressor at the ISP side is capable of meeting the throughput requirement. For example, the camera module may refer to information of the de-compression capability and requirement informed by the image signal processor to decide the throughput M (pixels per clock cycle) of one de-compressor in the image signal processor and the target throughput requirement N (pixels per clock cycle) of a circuit block following the image signal processor. Assume that the throughput of one compressor in the camera module is also M (pixels per clock cycle). When N/M is not greater than one, this means that using a single compressor at the camera side and a single de-compressor at the ISP side is capable of meeting the throughput requirement. Hence, the proposed data parallelism scheme is inactivated, and the conventional rate-controlled compression and de-compression is performed. When N/M is greater than one, this means that using a single compressor at the camera side and a single de-compressor at the ISP side is unable to meet the throughput requirement. Hence, the proposed data parallelism scheme is activated. In addition, the number of compressors enabled in the camera module and the number of de-compressors enabled in the image signal processor may be determined based on the value of N/M.

The pixel data splitting operation performed by the mapper 114 is to generate multiple pixel data groups that will undergo rate-controlled compression independently. However, it is possible that pixel data of adjacent pixel lines (e.g., pixel rows or pixel columns) in the original picture are categorized into different pixel data groups. The rate control generally optimizes the bit rate in terms of pixel context rather than pixel positions. The pixel boundary may introduce artifacts since the rate control is not aware of the boundary position. Taking the pixel data grouping design shown in FIG. 6 for example, the rate control applied to the pixel segment S₁ of the pixel row R₀ is independent of the rate control applied to the pixel segment S₂ of the same pixel row R₀. Specifically, the pixel segment S₁ is compressed in an order from P₀ to P_{M}, and the pixel segment S₂ is compressed in an order from P_{M+1} to P_{W-1}. Concerning the pixels P_{M} and P_{M+1} on opposite sides of the pixel boundary between pixel segments S₁ and S₂, the pixel P_{M} may be part of a compression unit with a first bit budget allocation, and the pixel P_{M+1} may be part of another compression unit with a second bit budget allocation different from the first bit budget allocation. The difference between the first bit budget allocation and the second bit budget allocation may be large. As a result, the rate controller 116 may allocate bit rates un-evenly on the pixel boundary, thus resulting in degraded image quality on the pixel boundary in a reconstructed picture. To avoid or mitigate the image quality degradation caused by artifacts on the pixel boundary, the present invention further proposes a position-aware rate control mechanism which optimizes the bit budget allocation in terms of pixel positions.

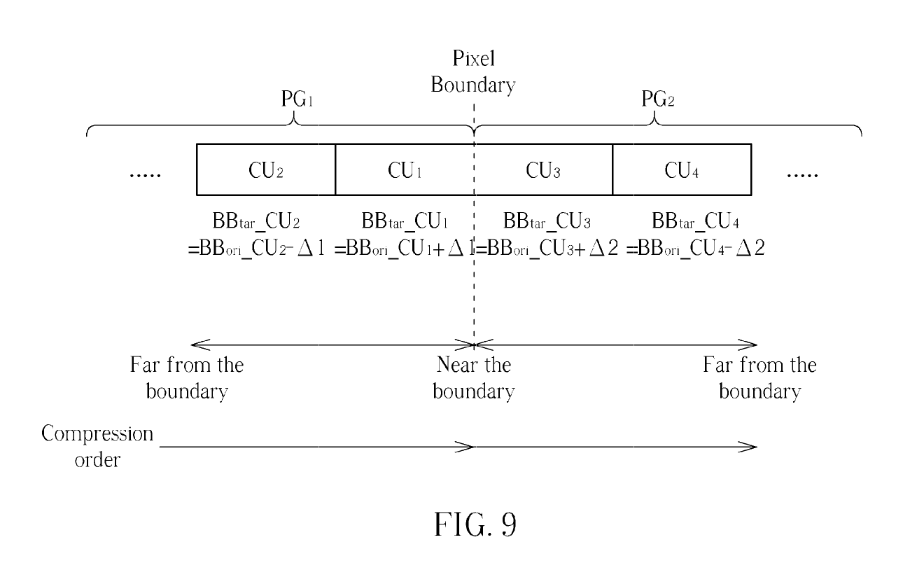

FIG. 9 is a diagram illustrating a position-aware rate control mechanism according to an embodiment of the present invention. As shown in FIG. 9, there are compression units CU1 and CU2 on one side of a pixel boundary and compression units CU3 and CU4 on the other side of the pixel boundary. The compression units CU1 and CU2 belong to one pixel group PG1, and the compression unit CU1 is nearer to the pixel boundary than the compression unit CU2. The compression units CU3 and CU4 belong to another pixel group PG2, and the compression unit CU3 is nearer to the pixel boundary than the compression unit CU4. In one exemplary embodiment, each of the compression units CU1-CU4 may include X×Y pixels, and the compression units CU1-CU4 may be horizontally or vertically adjacent in a picture. For example, X may be 4 and Y may be 2. When the position-aware rate control mechanism is activated, the rate controller 116 may be configured to adjust the bit rate control according to a position of each pixel boundary between different pixel groups. For example, the rate controller 116 increases an original bit budget BBori_CU1 assigned to the compression unit CU1 by an adjustment value Δ1 (Δ1>0) to thereby determine a final bit budget BBtar_CU1, and decreases an original bit budget BBori_CU2 assigned to the compression unit CU2 by the adjustment value Δ1 to thereby determine a final bit budget BBtar_CU2. In addition, the rate controller 116 increases an original bit budget BBori_CU3 assigned to the compression unit CU3 by an adjustment value Δ2 (Δ2>0) to thereby determine a final bit budget BBtar_CU3, and decreases an original bit budget BBori_CU4 assigned to the compression unit CU4 by the adjustment value Δ2 to thereby determine a final bit budget BBtar_CU4. The adjustment value Δ2 may be equal to or different from the adjustment value Δ1, depending upon actual design consideration. Since the proposed position-aware rate control tends to set a larger bit budget near the pixel boundary, the artifacts on the pixel boundary can be reduced. In this way, the image quality around the pixel boundary in a reconstructed picture can be improved.

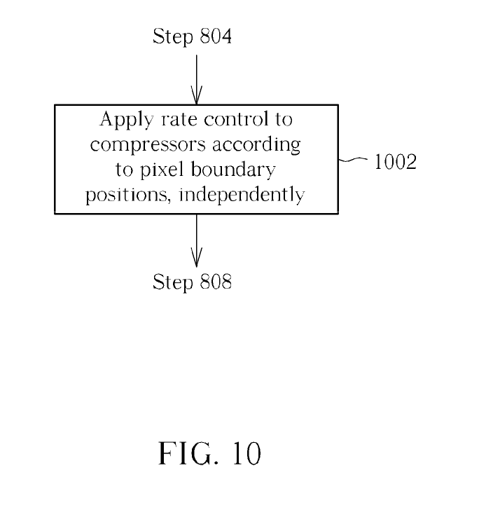

In a case where the position-aware rate control is employed, the flow shown in FIG. 8 may be modified to have step 806 replaced with the following step shown in FIG. 10.

Step 1002: Apply rate control to a plurality of compressors according to pixel boundary positions, independently.

As a person skilled in the art can readily understand details of step 1002 after reading above paragraphs, further description is omitted here for brevity.

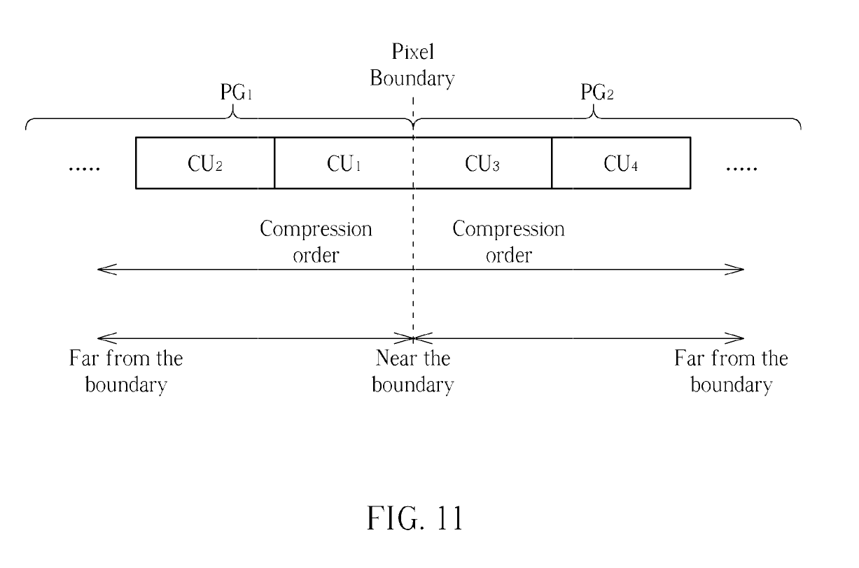

Taking the pixel data grouping design shown in FIG. 6 for example, the rate control applied to the pixel segment S₁ of the pixel row R₀ is independent of the rate control applied to the pixel segment S₂ of the same pixel row R₀. The pixel segment S₁ is compressed in an order from P₀ to P_{M}, and the pixel segment S₂ is compressed in an order from P_{M+1} to P_{W-i}. As a result, the bit budget allocation condition for the pixel P_{M} (which is the last compressed pixel in the pixel segment S₁) may be different from the bit budget allocation condition for the pixel P_{M+1} (which is the first compressed pixel in the pixel segment S₂). To avoid or reduce artifacts on the pixel boundary, the present invention further proposes a modified compression mechanism with compression orders set based on pixel boundary positions. FIG. 11 is a diagram illustrating a modified compression mechanism according to an embodiment of the present invention. As shown in FIG. 11, there are compression units CU₁ and CU₂ on one side of a pixel boundary and compression units CU₃ and CU₄ on the other side of the pixel boundary. The compression units CU₁ and CU₂ belong to one pixel group PG₁, and the compression unit CU₁ is nearer to the pixel boundary than the compression unit CU₂. The compression units CU₃ and CU₄ belong to another pixel group PG₂, and the compression unit CU₃ is nearer to the pixel boundary than the compression unit CU₄. In one exemplary embodiment, each of the compression units CU₁-CU₄ may include X×Y pixels, and the compression units CU₁-CU₄ may be horizontally or vertically adjacent in a picture. For example, X may be 4 and Y may be 2. When the modified compression mechanism is activated, each of the compressors 115_1 and 115_2 may be configured to set a compression order according to a position of each pixel boundary between different pixel groups. For example, the compressor 115_1 compresses the compression unit CU₁ prior to compressing the compression unit CU₂, and the compressor 115_2 compresses the compression unit CU₃ prior to compressing the compression unit CU₄. In other words, two adjacent pixel segments located at the same pixel line are compressed in opposite compression orders. Since the modified compression scheme starts the compression from compression units near the pixel boundary between adjacent pixel groups, the bit budget allocation conditions near the pixel boundary may be more similar. In this way, the image quality around the pixel boundary in a reconstructed picture can be improved. When the modified compression mechanism is activated at the camera side, the de-mapper 124 at the ISP side may be configured to further consider the compression orders when merging the de-compressed pixel data groups DG₃ and DG₄.

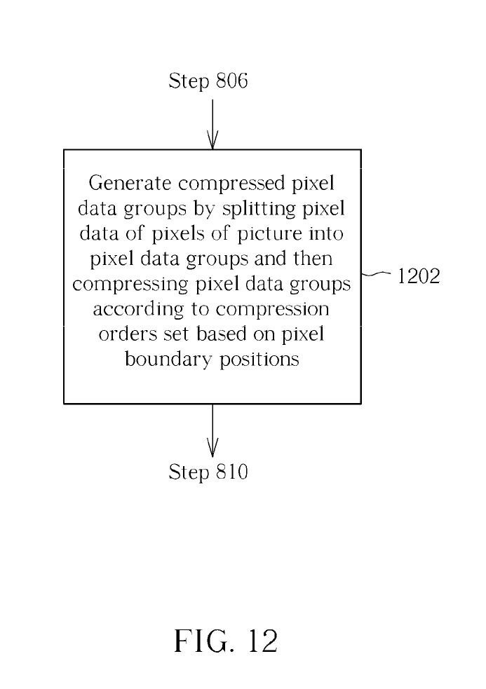

In a case where the modified compression mechanism is employed, the flow shown in FIG. 8 may be modified to have step 808 replaced with the following step shown in FIG. 12.

Step 1202: Generate a plurality of compressed pixel data groups by splitting pixel data of a plurality of pixels of a picture into a plurality of pixel data groups based on the pixel data grouping setting and using the compressors to compress the pixel data groups according to compression orders set based on pixel boundary positions.

As a person skilled in the art can readily understand details of step 1202 after reading above paragraphs, further description is omitted here for brevity.

Steps 814 and 816 in FIG. 8 are used to make the de-compression configuration in the image signal processor match the compression configuration in the camera sensor for allowing the data parallelism design to operate normally. Specifically, the de-compression configuration in the image signal processor and the compression configuration in the camera sensor can be properly set based on the proposed information handshaking mechanism illustrated as below.

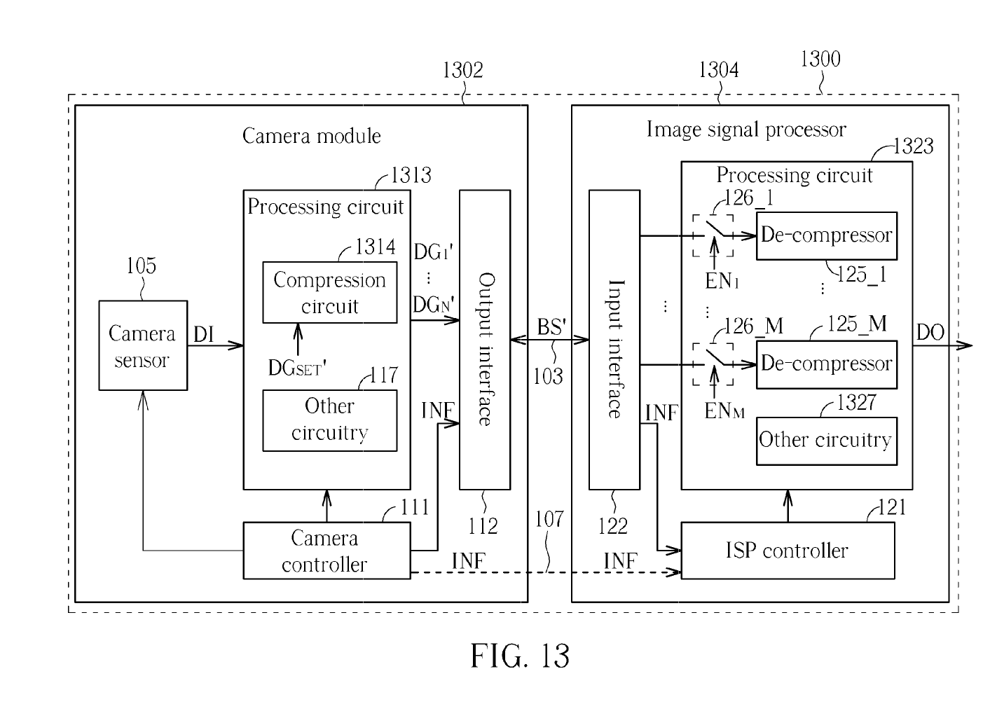

FIG. 13 is a block diagram illustrating another data processing system according to an embodiment of the present invention. The data processing system 1300 includes a plurality of data processing apparatuses such as a camera module 1302 and an image signal processor 1304. The image signal processor 1304 may be part of an application processor (AP). The camera module 1302 and the image signal processor 1304 may be implemented in different chips, and the camera module 1302 communicates with the image signal processor 1304 via the aforementioned camera interface (e.g., MIPI's CSI) 103.

The camera module 1302 is coupled to the camera interface 103, and supports compressed data transmission. The camera module 1302 includes a processing circuit 1313 and the aforementioned camera sensor 105, camera controller 111 and output interface 112. The processing circuit 1313 includes circuit elements required for processing the pixel data DI of pixels of one picture to generate a plurality of compressed pixel data groups DG₁′-DG_{N}′, where N is a positive integer. In this embodiment, the processing circuit 1313 includes a compression circuit 1314 and the aforementioned other circuitry 117. The compression circuit 1314 may have a mapper/splitter, a plurality of compressors, etc. For example, the compression circuit 1314 may include mapper 114, rate controller 116 and compressors 115_1-115_2 shown in FIG. 1.

Regarding the compression circuit 1314, it may use the mapper/splitter to split the pixel data DI of one picture into N pixel data groups according to a pixel data group setting DG_{SET}′. Next, the compression circuit 1314 may enable N compressors selected from a plurality of pre-built compressors to compress the N pixel data groups to generate the compressed pixel data groups DG₁′-DG_{N}′, respectively. Specifically, the number of enabled compressors depends on the number of pixel data groups. In addition, each of the enabled compressors may employ a lossless compression algorithm or a lossy compression algorithm, depending upon the actual design consideration. In this embodiment, compression operations performed by the enabled compressors are independent of each other. In this way, the compression throughput of the camera module 1302 can be improved due to data parallelism.

The output interface 112 is configured to pack/packetize the compressed pixel data groups DG₁′-DG_{N}′ into at least one output bitstream according to the transmission protocol of the camera interface 103, and transmit the at least one output bitstream to the image signal processor 1304 via the camera interface 103. By way of example, one bitstream BS′ may be generated from the camera module 1302 to the image signal processor 1304 via one camera port of the camera interface 103.

Regarding the image signal processor 1304, it communicates with the camera module 1302 via the camera interface 103. In this embodiment, the image signal processor 1304 is coupled to the camera interface 103, and supports compressed data reception. When the camera module 1302 transmits compressed multimedia data (e.g., compressed pixel data groups DG₁′-DG_{N}′ packed in the bitstream BS′) to the image signal processor 1304, the image signal processor 1304 is configured to receive the compressed multimedia data from the camera interface 103 and derive reconstructed multimedia data from the compressed multimedia data.

As shown in FIG. 13, the image signal processor 1304 includes a processing circuit 1323 and the aforementioned ISP controller 121 and input interface 122. The input interface 122 is configured to receive at least one input bitstream from the camera interface 103 (e.g., the bitstream BS′ received by one camera port of the camera interface 103), and un-pack/un-packetize the at least one input bitstream into a plurality of compressed pixel data groups of a picture (e.g., N compressed pixel data groups). It should be noted that, if there is no error introduced during the data transmission, the compressed pixel data groups generated from the input interface 122 should be identical to the compressed pixel data groups DG₁′-DG_{N}′ received by the output interface 112.

The processing circuit 1323 may include circuit elements required for deriving reconstructed multimedia data from the compressed multimedia data, and may further include other circuit element(s) used for applying additional processing before outputting pixel data DO of a plurality of pixels of a reconstructed picture. In this embodiment, the processing circuit 1323 has a plurality of de-compressors (e.g., M de-compressors 125_1-125_M, where M is a positive integer and M≧N), a plurality of switches (e.g., M switches 126_1-126_M), and other circuitry 1327. The other circuitry 1327 may have a de-mapper/combiner (e.g., the de-mapper 124 shown in FIG. 1), DMA controllers, multiplexers, an image processor, a camera processor, a video processor, a graphic processor, etc.

Each of the de-compressors 125_1-125_M is configured to decompress a compressed pixel data group when selected. It should be noted that the number of switches 126_1-126_M is equal to the number of de-compressors 125_1-125_M. Hence, each of the switches 126_1-126_M controls whether a corresponding de-compressor is selected for data de-compression. In this embodiment, the switches 126_1-126_M are respectively controlled by a plurality of enable signals EN₁-EN_{M} generated from the ISP controller 121. When an enable signal has a first logic value (e.g., ‘1’), a corresponding switch is enabled (i.e., switched on) to make a following de-compressor selected; and when the enable signal has a second logic value (e.g., ‘0’), the corresponding switch is disabled (i.e., switched off) to make a following de-compressor unselected.

The image signal processor 1304 has multiple pre-built de-compressors (e.g., multiple cores) so as to realize different de-compression capability (or throughput). In this embodiment, since the input interface 122 obtains N compressed pixel data groups from de-packing/de-packetizing the bitstream BS′, the ISP controller 121 is configured to select N de-compressors from the de-compressors 125_1-125_M for data de-compression. In this embodiment, the unselected (M−N) de-compressors may be clock-gated for power saving. The selected de-compressors are used to de-compress the N compressed pixel data groups to generate a plurality of de-compressed pixel data groups, respectively. In this embodiment, the de-compression operations performed by the selected de-compressors are independent of each other. In this way, the de-compression throughput is improved due to data parallelism.

The de-compression algorithm employed by each of the selected de-compressors in the image signal processor 1304 should be properly configured to match the compression algorithm employed by each of the compressors in the compression circuit 1314. In other words, the selected de-compressors are configured to perform lossless de-compression when the compressors in the compression circuit 1314 are configured to perform lossless compression; and the selected de-compressors are configured to perform lossy de-compression when the compressors in the compression circuit 1314 are configured to perform lossy compression. The de-mapper/combiner (not shown) in the other circuit 1327 is configured to merge the de-compressed pixel data groups into pixel data DO of a plurality of pixels of a reconstructed picture based on the pixel data grouping setting DG_{SET}′ that is employed by a mapper/splitter (now shown) in the compression circuit 1314.

The pixel data group setting DG_{SET}′ is related to the number of pixel data groups processed by the compression circuit 1314. In other words, the pixel data group setting DG_{SET}′ is related to the number of enabled compressors in the compression circuit 1314. In one exemplary implementation, the pixel data grouping setting DG_{SET}′ employed by the compression circuit 1314 may be transmitted from the camera module 1302 to the image signal processor 1304 via an in-band channel (i.e., camera interface 103). Specifically, the camera controller 111 controls the operation of the camera module 1302, and the ISP controller 121 controls the operation of the image signal processor 1304. Hence, the camera controller 111 may first check a de-compression capability and requirement of the image signal processor 1304, and then determine the number of pixel data groups in response to a checking result. In addition, the camera controller 111 may further determine the pixel data grouping setting DG_{SET}′ employed by the compression circuit 1314 to generate the pixel data groups that satisfy the de-compression capability and requirement of the image signal processor 1304, and transmit the pixel data grouping setting DG_{SET}′ over camera interface 103. When receiving a query issued from the camera controller 111, the ISP controller 121 informs the camera controller 111 of the de-compression capability and requirement of the image signal processor 1304. In addition, when receiving the pixel data grouping setting DG_{SET}′ from camera interface 103, the ISP controller 121 refers to the received pixel data grouping setting DG_{SET}′ to properly set the enable signals EN₁-EN_{M}, such that multiple de-compressors are correctly selected for data de-compression.

For example, the camera module 1302 may refer to information of the de-compression capability and requirement informed by the image signal processor 1304 to decide the throughput P1 (pixels per clock cycle) of one de-compressor in the image signal processor 1304 and the target throughput requirement P2 (pixels per clock cycle) of a circuit block following the image signal processor 1304. Assume that the throughput of one compressor in the camera module 1302 is also P1 (pixels per clock cycle). When P2/P1 is not greater than one, this means that using a single compressor at the camera side and a single de-compressor at the ISP side is capable of meeting the throughput requirement. Hence, the proposed data parallelism scheme is inactivated, and the conventional compression and de-compression is performed. In this case, the enable signals EN₁-EN₄ may be set by {1, 0, 0, 0} for allowing a single de-compressor to be enabled. When P2/P1 is greater than one, this means that using a single compressor at the camera side and a single de-compressor at the ISP side is unable to meet the throughput requirement. Hence, the proposed data parallelism scheme is activated. In addition, the number of compressors enabled in the camera module 1302 and the number of de-compressors enabled in the image signal processor 1304 may be determined based on the value of P2/P1 (which will be considered by the camera controller 111 to determine the pixel data grouping setting DG_{SET}′).

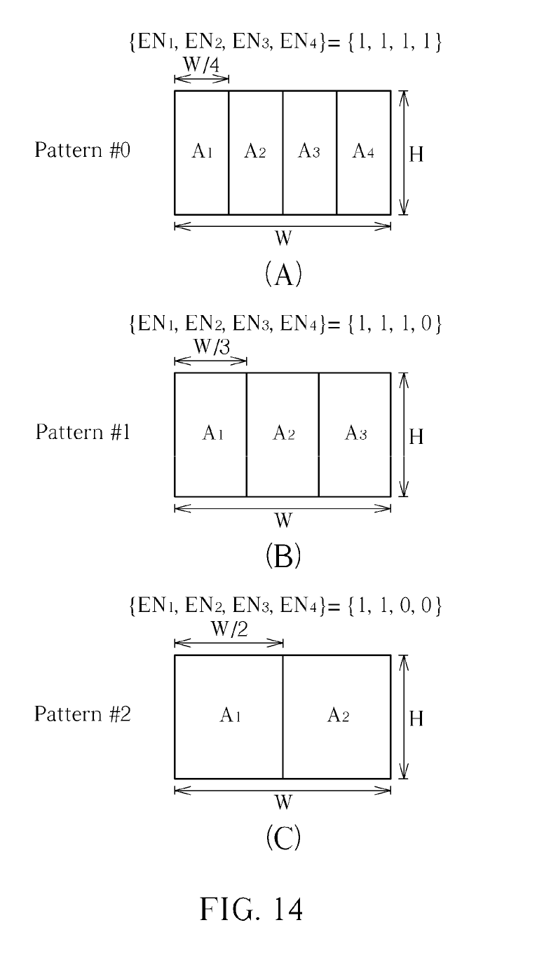

By way of example, but not limitation, several pixel data grouping patterns may be used to split pixel data of a plurality of pixels of one picture into multiple pixel data groups. FIG. 14 is a diagram illustrating exemplary pixel data grouping patterns each dividing one picture in a first direction. Suppose that the number of de-compressors 125_1-125_M implemented in the image signal processor 1304 is four (i.e., M=4). Hence, the four enable signals EN₁-EN₄ should be properly set to decide which de-compressors should be used for de-compression. When the pixel data grouping pattern in sub-diagram (A) of FIG. 14 is employed, the pixel data grouping setting DG_{SET}′ is set by the camera controller 111 to instruct the mapper/splitter in the compression circuit 1314 to split one picture with a resolution of W×H into four sub-pictures A₁, A₂, A₃, A₄ each having a resolution of (W/4)×H. Hence, the number of compressed pixel data groups DG₁′-DG_{N}′ generated from the compression circuit 1314 is equal to four (i.e., N=4). For example, the compression circuit 1314 enables four compressors to compress pixel data of the sub-pictures A₁-A₄ into four compressed pixel data groups, respectively. Hence, when receiving the pixel data grouping setting DG_{SET}′, the ISP controller 121 sets the enable signals EN₁-EN₄ by {1, 1, 1, 1}, such that four de-compressors are selected to decompress the four compressed pixel data groups, respectively.

When the pixel data grouping pattern in sub-diagram (B) of FIG. 14 is employed, the pixel data grouping setting DG_{SET}′ is set by the camera controller 111 to instruct the mapper/splitter in the compression circuit 1314 to split one picture with a resolution of W×H into three sub-pictures A₁, A₂, A₃ each having a resolution of (W/3)×H. Hence, the number of compressed pixel data groups DG₁′-DG_{N}′ generated from the compression circuit 1314 is equal to three (i.e., N=3). For example, the compression circuit 1314 enables three compressors to compress pixel data of the sub-pictures A₁-A₃ into three compressed pixel data groups, respectively. Hence, when receiving the pixel data grouping setting DG_{SET}′, the ISP controller 121 sets the enable signals EN₁-EN₄ by {1, 1, 1, 0}, such that three de-compressors are selected to decompress the three compressed pixel data groups, respectively.

When the pixel data grouping pattern in sub-diagram (C) of FIG. 14 is employed, the pixel data grouping setting DG_{SET}′ is set by the camera controller 111 to instruct the mapper/splitter in the compression circuit 1314 to split one picture with a resolution of W×H into two sub-pictures A₁ and A₂ each having a resolution of (W/2)×H. Hence, the number of compressed pixel data groups DG₁′-DG_{N}′ generated from the compression circuit 1314 is equal to two (i.e., N=2). For example, the compression circuit 1314 enables two compressors to compress pixel data of the sub-pictures A₁ and A₂ into two compressed pixel data groups, respectively. Hence, when receiving the pixel data grouping setting DG_{SET}′, the ISP controller 121 sets the enable signals EN₁-EN₄ by {1, 1, 0, 0}, such that two de-compressors are selected to decompress the two compressed pixel data groups, respectively.

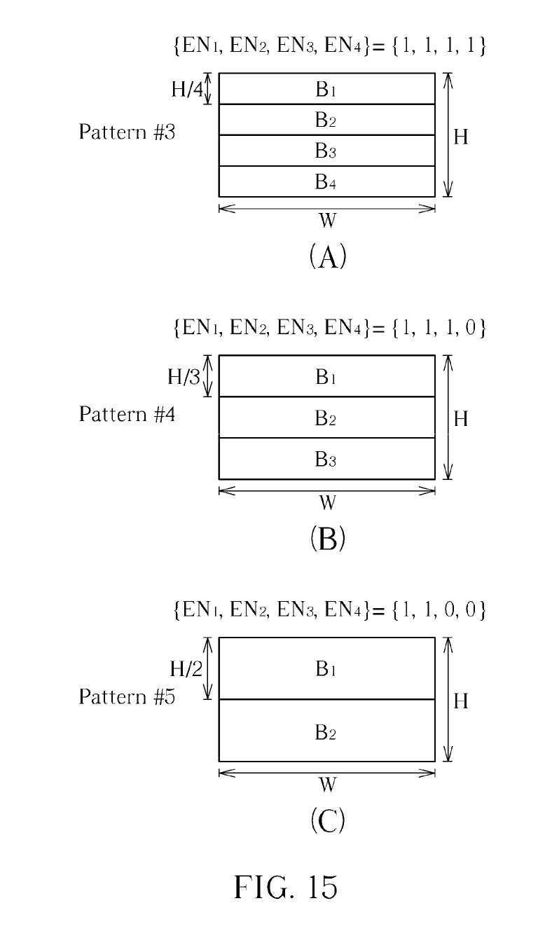

In above exemplary pixel data grouping patterns shown in FIG. 14, each pixel row of a picture is divided into multiple segments, while each pixel column of the same picture remains intact. Alternatively, each pixel column of a picture may be divided into multiple segments, while each pixel row in the same picture may remain intact. FIG. 15 is a diagram illustrating exemplary pixel data grouping patterns each dividing one picture in a second direction. When the pixel data grouping pattern in sub-diagram (A) of FIG. 15 is employed, the pixel data grouping setting DG_{SET}′ is set by the camera controller 111 to instruct the mapper/splitter in the compression circuit 1314 to split one picture with a resolution of W×H into four sub-pictures B₁, B₂, B₃, B₄ each having a resolution of W×(H/4). Hence, the number of compressed pixel data groups DG₁′-DG_{N}′ generated from the compression circuit 1314 is equal to four (i.e., N=4). For example, the compression circuit 1314 enables four compressors to compress pixel data of the sub-pictures B₁-B₄ into four compressed pixel data groups, respectively. Hence, when receiving the pixel data grouping setting DG_{SET}′, the ISP controller 121 sets the enable signals EN₁-EN₄ by {1, 1, 1, 1}, such that four de-compressors are selected to decompress the four compressed pixel data groups, respectively.

When the pixel data grouping pattern in sub-diagram (B) of FIG. 15 is employed, the pixel data grouping setting DG_{SET}′ is set by the camera controller 111 to instruct the mapper/splitter in the compression circuit 1314 to split one picture with a resolution of W×H into three sub-pictures B₁, B₂, B₃ each having a resolution of W×(H/3). Hence, the number of compressed pixel data groups DG₁′-DG_{N}′ generated from the compression circuit 1314 is equal to three (i.e., N=3). For example, the compression circuit 1314 enables three compressors to compress pixel data of the sub-pictures B₁-B₃ into three compressed pixel data groups, respectively. Hence, when receiving the pixel data grouping setting DG_{SET}′, the ISP controller 121 sets the enable signals EN₁-EN₄ by {1, 1, 1, 0}, such that three de-compressors are selected to decompress the three compressed pixel data groups, respectively.

When the pixel data grouping pattern in sub-diagram (C) of FIG. 15 is employed, the pixel data grouping setting DG_{SET}′ is set to instruct the mapper/splitter in the compression circuit 1314 to split one picture with a resolution of W×H into two sub-pictures B₁ and B₂ each having a resolution of W×(H/2). Hence, the number of compressed pixel data groups DG₁′-DG_{N}′ generated from the compression circuit 1314 is equal to two (i.e., N=2). For example, the compression circuit 1314 enables two compressors to compress pixel data of the sub-pictures B₁ and B₂ into two compressed pixel data groups, respectively. Hence, when receiving the pixel data grouping setting DG_{SET}′, the ISP controller 121 sets the enable signals EN₁-EN₄ by {1, 1, 0, 0}, such that two de-compressors are selected to decompress the two compressed pixel data groups, respectively.

As shown in FIG. 14, the horizontal image partitioning is applied to a picture, thus resulting in multiple sub-pictures arranged horizontally in the picture. As shown in FIG. 15, the vertical image partitioning is applied to a picture, thus resulting in multiple sub-pictures arranged vertically in the picture. However, these are for illustrative purposes only, and are not meant to be limitations of the present invention. In practice, the present invention has no limitation on the design of the pixel data grouping pattern. For example, one picture may be split into sub-pictures based on a line-by-line interleaving pattern. In this way, each sub-picture is composed of pixels of one pixel line (e.g., a pixel row or a pixel column). For another example, one picture may be split into sub-pictures based on a checkerboard pattern. In this way, each sub-picture is composed of pixels of one A×B block, where A and B are positive integers, and A may be equal to or different from B. These alternative pixel data grouping pattern designs all fall within the scope of the present invention.

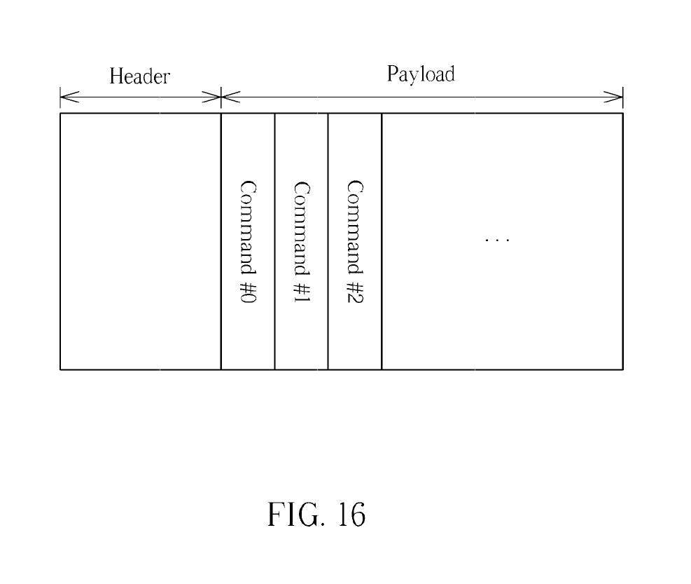

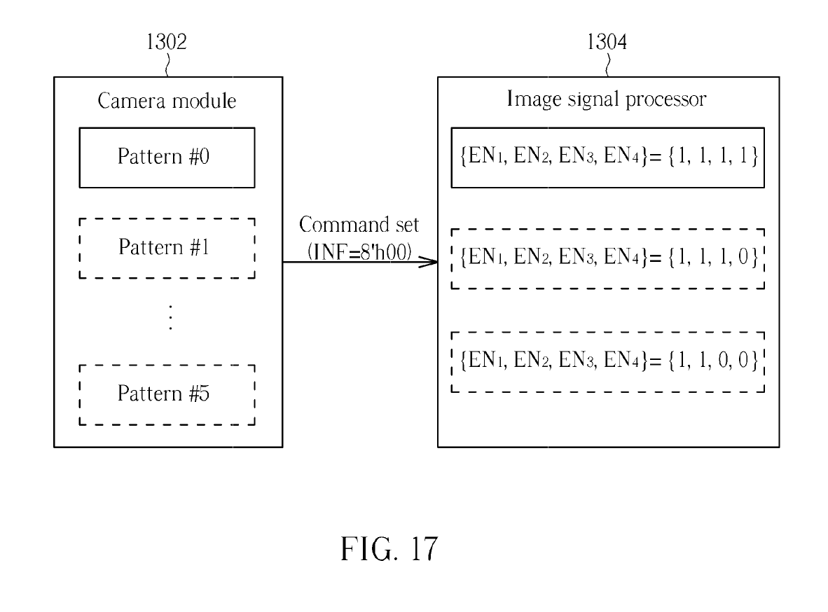

In one exemplary implementation, the output interface 112 records indication information INF of the pixel data grouping setting DG_{SET}′ in the output bitstream by setting a command set in a payload portion of the output bitstream transmitted over the camera interface 103, and the input interface 122 obtains the indication information INF of the pixel data grouping setting DG_{SET}′ by parsing a command set in a payload portion of the input bitstream received from the camera interface 103. Please refer to FIG. 16, which is a diagram illustrating a data structure of the output bitstream generated from the camera module 1302 to the image signal processor 1304 according to an embodiment of the present invention. The information handshaking between the camera module 1302 and the image signal processor 1304 may be realized by defining a set of commands in the transmitted payload. For example, these commands can be specified in either a user command set or a manufactured command set based on a camera command set (CCS) specification, where each command in a command set may be an 8-bit code, and the command set can be used to communicate between the camera module 1302 and the image signal processor 1304 about the pixel data grouping setting DG_{SET}′. Please refer to FIG. 17, which is a diagram illustrating an example of information handshaking between the camera module 1302 and the image signal processor 1304. In this example, the camera module 1302 may support at least six pixel data grouping patterns, as shown in FIG. 14 and FIG. 15. In addition, the image signal processor 1304 may support at least three settings for enable signals EN₁-EN₄, as shown in FIG. 14 and FIG. 15. The camera module 1302 checks a de-compression capability and requirement of the image signal processor 1304 by sending a request to the image signal processor 1304 through the camera interface 103, and the image signal processor 1304 informs the camera module 1302 of its de-compression capability and requirement by sending a response to the camera module 1302 through the camera interface 103. Based on the information given by the image signal processor 1304, the camera module 1302 determines the pixel data grouping setting DG_{SET}′ by using the pixel data grouping pattern #0. Hence, the indication information INF is set by an 8-bit code 8′h00 to indicate the use of the pixel data grouping pattern #0. The indication information INF is carried by the command set transmitted from the camera module 1302 to the image signal processor 1304 via the camera interface 103. The image signal processor 1304 receives the indication information INF through the camera interface 103, and refers to the 8-bit code 8′h00 to know that the pixel data grouping pattern #0 is selected by the camera module 1302. Hence, based on the indication information INF of the pixel data grouping setting DG_{SET}′, the image signal processor 1304 sets the enable signals EN₁-EN₄ by {1, 1, 1, 1} correspondingly.

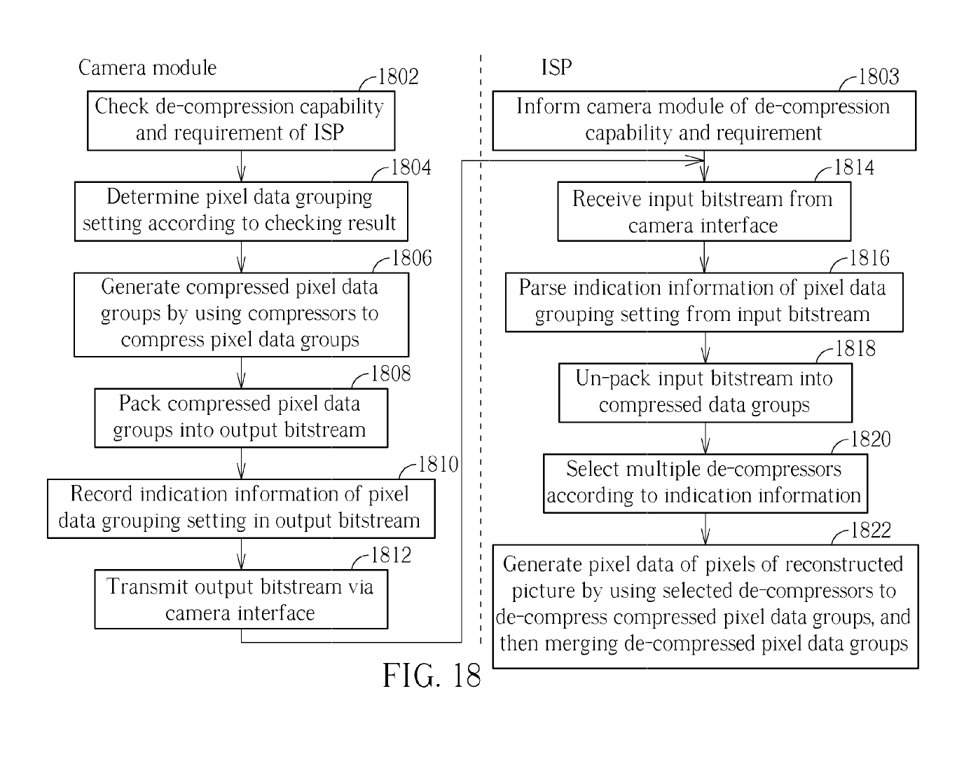

FIG. 18 is a flowchart illustrating a control and data flow of the data processing system 1300 shown in FIG. 13 according to an embodiment of the present invention. Provided that the result is substantially the same, the steps are not required to be executed in the exact order shown in FIG. 18. The exemplary control and data flow may be briefly summarized by following steps.

Step 1802: Check a de-compression capability and requirement of an image signal processor (ISP).

Step 1803: Inform a camera module of the de-compression capability and requirement.

Step 1804: Determine a pixel data grouping setting according to a checking result. For example, one of the pixel data grouping patterns shown in FIG. 14 and FIG. 15 may be selected.

Step 1806: Generate a plurality of compressed pixel data groups by using compressors to compress a plurality of pixel data groups obtained from pixel data of a plurality of pixels of a picture based on the pixel data grouping setting.

Step 1808: Pack/packetize the compressed pixel data groups into an output bitstream.

Step 1810: Record indication information of the pixel data grouping setting in the output bitstream. For example, the indication information is recorded in a command set of a payload portion of the output bitstream.

Step 1812: Transmit the output bitstream via a camera interface.

Step 1814: Receive an input bitstream from the camera interface.

Step 1816: Parse indication information of the pixel data grouping setting from the input bitstream. For example, the indication information is obtained from a command set of a payload portion of the input bitstream.

Step 1818: Un-pack/un-packetize the input bitstream into a plurality of compressed data groups.

Step 1820: Select multiple de-compressors according to the indication information.

Step 1822: Generate pixel data of a plurality of pixels of a reconstructed picture by using the selected de-compressors to de-compress the compressed pixel data groups, independently, and then merging a plurality of de-compressed pixel data groups based on the pixel data grouping setting as indicated by the indication information.

It should be noted that steps 1802 and 1804-1812 are performed by the camera module 1302, and steps 1803 and 1814-1822 are performed by the image signal processor 1304. As a person skilled in the art can readily understand details of each step shown in FIG. 18 after reading above paragraphs, further description is omitted here for brevity.

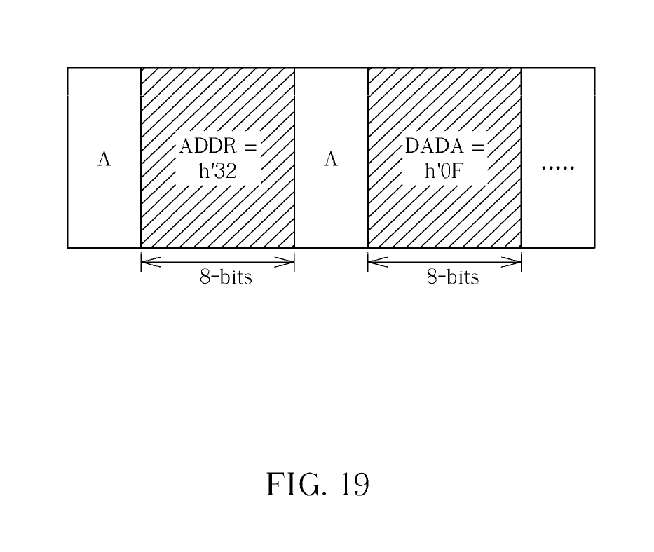

In another exemplary implementation, the pixel data grouping setting DG_{SET}′ may be transmitted from the camera sensor 1302 to the image signal processor 1304 via the out-of-band channel 107, such as an I²C bus or a CCI bus. For example, the camera controller 111 may write the indication information INF of the pixel data grouping setting DG_{SET}′ into at least one control resister through the out-of-band channel 107. FIG. 19 is a diagram illustrating an example of using an I²C protocol with compression command according to an embodiment of the present invention. The image signal processor 1304 may be a slave device on the I²C bus, and the camera module 1302 may be a master device on the I²C bus. The ISP controller 121 of image signal processor 1304 sends a type-A message (e.g., an acknowledgment message) to the camera controller 111 of camera module 1302, and then the camera controller 111 of camera module 1302 selects a control register at the address h′32 by sending an 8-bit command ADDR=h′32 to the ISP controller 121 of image signal processor 1304. Next, the ISP controller 121 of image signal processor 1304 sends another type-A message (e.g., another acknowledgment message) to the camera controller 111 of camera module 1302, and then the camera controller 111 of camera module 1302 outputs the indication information INF to be recorded into the selected control register by sending an 8-bit command DATA=h′0F to the ISP controller 121 of image signal processor 1304. Based on the indication information INF (which is recorded by setting the control register at the address h′32 by h′0F), the image signal processor 1304 sets the enable signals EN₁-EN₄ by {1, 1, 1, 1} correspondingly.

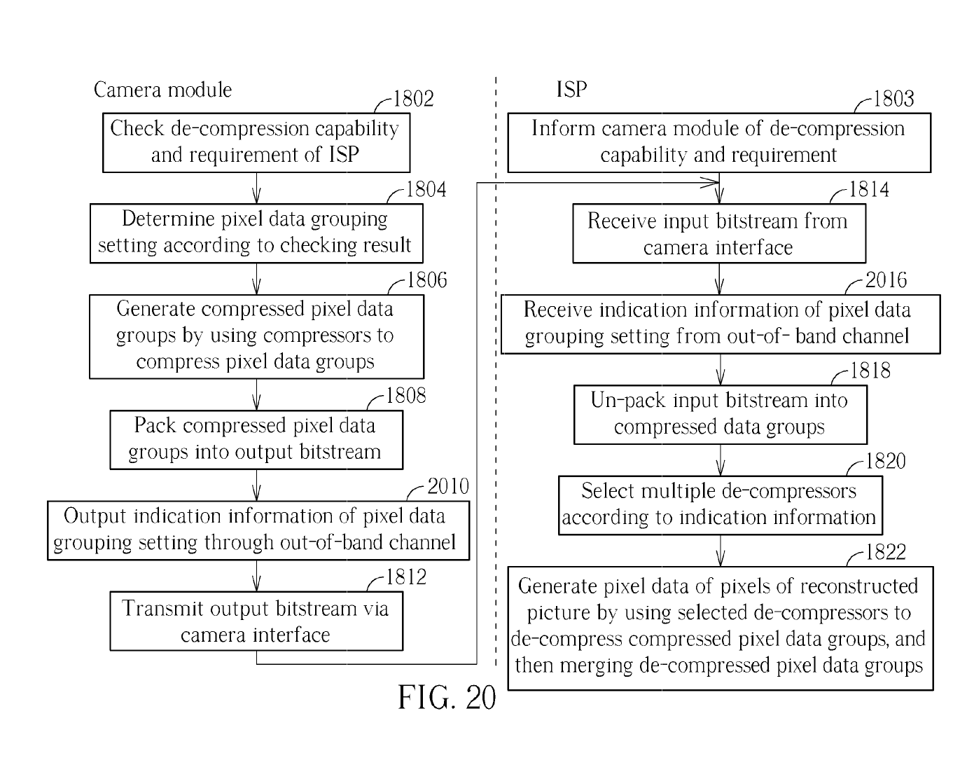

FIG. 20 is a flowchart illustrating another control and data flow of a data processing system shown in FIG. 13 according to an embodiment of the present invention. The major difference between the flowcharts shown in FIG. 20 and FIG. 18 is that steps 1810 and 1816 are replaced by following steps 2010 and 2016, respectively.

Step 2010: Output indication information of the pixel data grouping setting through an out-of-band channel (e.g., I²C bus or CCI bus).

Step 2016: Receive the indication information of the pixel data grouping setting from the out-of-band channel (e.g., I²C bus or CCI bus).

It should be noted that step 2010 is performed by the camera module 1302, and step 2016 is performed by the image signal processor 1304. As a person skilled in the art can readily understand details of each step shown in FIG. 20 after reading above paragraphs, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

1. A data processing apparatus, comprising:
a mapper, configured to receive pixel data of a plurality of pixels of a picture, and splitting the pixel data of the pixels of the picture into a plurality of pixel data groups;
a plurality of compressors, configured to compress the pixel data groups and generate a plurality of compressed pixel data groups, respectively; and
an output interface, configured to pack the compressed pixel data groups into at least one output bitstream, and output the at least one output bitstream via a camera interface.

2. The data processing apparatus of claim 1, wherein compression operations performed by the compressors are independent of each other.

3. The data processing apparatus of claim 2, further comprising:
a rate controller, configured to apply bit rate control to the compressors, respectively.

4. The data processing apparatus of claim 1, wherein the camera interface is a camera serial interface (CSI) standardized by a Mobile Industry Processor Interface (MIPI).

5. The data processing apparatus of claim 1, wherein pixel data of each pixel of the picture includes a plurality of bits corresponding to different bit planes, and the mapper is configured to split the bits of the pixel data of each pixel of the picture into a plurality of bit groups, and distribute the bit groups to the pixel data groups, respectively.

6. The data processing apparatus of claim 1, wherein the mapper is configured to split the pixels of the picture into a plurality of pixel groups, and distribute pixel data of the pixel groups to the pixel data groups, respectively.

7. The data processing apparatus of claim 6, wherein adjacent pixels located at a same pixel line of the picture are distributed to different pixel groups, respectively.

8. The data processing apparatus of claim 6, wherein adjacent pixel segments located at a same pixel line of the picture are distributed to different pixel groups, respectively, and each of the adjacent pixel segments includes a plurality of successive pixels.

9. The data processing apparatus of claim 8, wherein at least one pixel line of the picture is divided into a plurality of pixel segments, and a number of the pixel segments is equal to a number of the pixel data groups.

10. The data processing apparatus of claim 8, wherein at least one pixel line of the picture is divided into a plurality of pixel segments, and a number of the pixel segments is larger than a number of the pixel data groups.

11. The data processing apparatus of claim 6, further comprising:
a rate controller, configured to apply bit rate control to the compressors, respectively;
wherein the rate controller adjusts the bit rate control according to a position of each pixel boundary between different pixel groups.

12. The data processing apparatus of claim 11, wherein concerning a specific pixel boundary between a first pixel group and a second pixel group, the rate controller is configured to increase an original bit budget assigned to a first compression unit by an adjustment value and decrease an original bit budget assigned to a second compression unit by the adjustment value; the first compression unit and the second compression unit are adjacent compression units in any of the first pixel group and the second pixel group; and the first compression unit is nearer to the specific pixel boundary than the second compression unit.

13. The data processing apparatus of claim 6, wherein each of the compressors is further configured to set a compression order according to a position of each pixel boundary between different pixel groups.

14. The data processing apparatus of claim 13, wherein concerning a specific pixel boundary between a first pixel group and a second pixel group, a first compressor is configured to compress a first compression unit prior to compressing a second compression unit, and a second compressor is configured to compress a third compression unit prior to compressing a fourth compression unit; the first compression unit and the second compression unit are adjacent compression units in the first pixel group, and the first compression unit is nearer to the specific pixel boundary than the second compression unit; and the third compression unit and the fourth second compression unit are adjacent compression units in the second pixel group, and the third compression unit is nearer to the specific pixel boundary than the fourth compression unit.

15. The data processing apparatus of claim 1, wherein the data processing apparatus is coupled to another data processing apparatus via the camera interface; and the mapper is further configured to inform the another data processing apparatus of a pixel data grouping setting employed to split the pixel data of the pixels of the picture.

16. The data processing apparatus of claim 1, wherein the data processing apparatus is coupled to another data processing apparatus via the camera interface, and the data processing apparatus further comprises:
a controller, configured to check a de-compression capability and requirement of the another data processing apparatus, and determines a number of the pixel data groups in response to a checking result.

17. A data processing apparatus, comprising:
an input interface, configured to receive at least one input bitstream from a camera interface, and un-pack the at least one input bitstream into a plurality of compressed pixel data groups of a picture;
a plurality of de-compressors, configured to de-compress the compressed pixel data groups and generate a plurality of de-compressed pixel data groups, respectively; and
a de-mapper, configured to merge the de-compressed pixel data groups into pixel data of a plurality of pixels of the picture.

18. The data processing apparatus of claim 17, wherein de-compression operations performed by the de-compressors are independent of each other.

19. The data processing apparatus of claim 17, wherein the camera interface is a camera serial interface (CSI) standardized by a Mobile Industry Processor Interface (MIPI).

20. The data processing apparatus of claim 17, wherein pixel data of each pixel of the picture includes a plurality of bits corresponding to different bit planes, and the de-mapper is configured to obtain a plurality of bit groups from the de-compressed pixel data groups, respectively, and merge the bit groups to obtain the bits of the pixel data of each pixel of the picture.

21. The data processing apparatus of claim 17, wherein the de-mapper is configured to obtain pixel data of a plurality of pixel groups from the de-compressed pixel data groups, respectively, and merge the pixel data of the pixel groups to obtain the pixel data of the pixels of the picture.

22. The data processing apparatus of claim 21, wherein adjacent pixels located at a same pixel line of the picture are obtained from different pixel groups, respectively.

23. The data processing apparatus of claim 21, wherein adjacent pixel segments located at a same pixel line of the picture are obtained from different pixel groups, respectively, and each of the adjacent pixel segments includes a plurality of successive pixels.

24. The data processing apparatus of claim 23, wherein at least one pixel line of the picture is obtained by merging a plurality of pixel segments, and a number of the pixel segments is equal to a number of the de-compressed pixel data groups.

25. The data processing apparatus of claim 23, wherein at least one pixel line of the picture is obtained by merging a plurality of pixel segments, and a number of the pixel segments is larger than a number of the de-compressed pixel data groups.

26. The data processing apparatus of claim 17, wherein the data processing apparatus is coupled to another data processing apparatus via the camera interface; and the de-mapper is further configured to receive a pixel data grouping setting of splitting the pixel data of the pixels of the picture from the another data processing apparatus.

27. The data processing apparatus of claim 17, wherein the data processing apparatus is coupled to another data processing apparatus via the camera interface, and the data processing apparatus further comprises:
a controller, configured to inform the another data processing apparatus of a de-compression capability and requirement of the data processing apparatus.

28. A data processing apparatus, comprising:
a compression circuit, configured to generate a plurality of compressed pixel data groups by compressing pixel data of a plurality of pixels of a picture based on a pixel data grouping setting of the picture;
a first output interface, configured to pack the compressed pixel data groups into an output bitstream, and output the output bitstream via a camera interface; and
a second output interface, distinct from the first output interface;
wherein indication information is set in response to the pixel data grouping setting employed by the compression circuit, and outputted via one of the first output interface and the second output interface.

29. The data processing apparatus of claim 28, wherein the camera interface is a camera serial interface (CSI) standardized by a Mobile Industry Processor Interface (MIPI).

30. The data processing apparatus of claim 28, wherein the first output interface is further configured to record the indication information in the output bitstream by setting a command set in a payload portion of the output bitstream.

31. The data processing apparatus of claim 28, wherein the second output interface is configured to output the indication information via a camera control interface (CCI) standardized by a Mobile Industry Processor Interface (MIPI).

32. The data processing apparatus of claim 28, wherein the data processing apparatus is coupled to another data processing apparatus via the camera interface, and the data processing apparatus further comprises:
a controller, configured to check a de-compression capability and requirement of the another data processing apparatus, and determine the pixel data grouping setting of the picture in response to a checking result.

33. A data processing apparatus, comprising:
a plurality of de-compressors, each configured to decompress a compressed pixel data group derived from an input bitstream when enabled;
a first input interface, configured to receive the input bitstream via a camera interface; and
a second input interface, distinct from the first input interface;
wherein indication information is received from one of the first input interface and the second interface, and multiple de-compressors selected from the de-compressors are enabled based on the received indication information.

34. The data processing apparatus of claim 33, wherein the camera interface is a camera serial interface (CSI) standardized by a Mobile Industry Processor Interface (MIPI).

35. The data processing apparatus of claim 33, wherein the first input interface is further configured to obtain the indication information by parsing a command set in a payload portion of the input bitstream.

36. The data processing apparatus of claim 33, wherein the second input interface is further configured to receive the indication information from a camera control interface (CCI) standardized by a Mobile Industry Processor Interface (MIPI).

37. The data processing apparatus of claim 33, wherein the data processing apparatus is coupled to another data processing apparatus via the camera interface, and the data processing apparatus further comprises:
a controller, configured to inform the another data processing apparatus of a de-compression capability and requirement of the data processing apparatus.

38. A data processing method, comprising:
receiving pixel data of a plurality of pixels of a picture, and splitting the pixel data of the pixels of the picture into a plurality of pixel data groups;
compressing the pixel data groups to generate a plurality of compressed pixel data groups, respectively; and
packing the compressed pixel data groups into at least one output bitstream, and outputting the at least one output bitstream via a camera interface.

39. A data processing method, comprising:
receiving at least one input bitstream from a camera interface, and un-packing the at least one input bitstream into a plurality of compressed pixel data groups of a picture;
de-compressing the compressed pixel data groups to generate a plurality of de-compressed pixel data groups, respectively; and
merging the de-compressed pixel data groups into pixel data of a plurality of pixels of the picture.

40. A data processing method, comprising:
generating a plurality of compressed pixel data groups by compressing pixel data of a plurality of pixels of a picture based on a pixel data grouping setting of the picture;
packing the compressed pixel data groups into an output bitstream, and outputting the output bitstream via a camera interface;
wherein indication information is set in response to the pixel data grouping setting, and output via one of the camera interface and an out-of-band channel distinct from the camera interface.

41. A data processing method, comprising:
receiving an input bitstream via a camera interface; and
enabling at least one de-compressor selected from a plurality of de-compressors based on indication information received from one of the camera interface and an out-of-band channel, wherein the out-of-band channel is distinct from the camera interface, and each of the de-compressors is configured to decompress a compressed pixel data group derived from the input bitstream when enabled.
